(19) United States
(12) Patent Application Publication
(10) Pub. No.: US 2026/0161827 A1
(43) Pub. Date: Jun. 11, 2026

(54) METHODS, ARCHITECTURES, APPARATUSES AND SYSTEMS DIRECTED TO APPLICATION-AWARE COMPUTING AND COMMUNICATION MANAGEMENT IN A BLOCKCHAIN SYSTEM

(71) Applicant: InterDigital Patent Holdings, Inc., Wilmington, DE (US)

(72) Inventors: Xu Li, Plainsboro, NJ (US); Chonggang Wang, Princeton, NJ (US); Robert Gazda, Spring City, PA (US); Debashish Purkayastha, Eagleville, PA (US)

(21) Appl. No.: 19/126,795

(22) PCT Filed: Nov. 3, 2023
(86) PCT No.: PCT/US2023/036790

§ 371 Date: May 2, 2025

Related U.S. Application Data
(60) Provisional application No. 63/422,927, filed on Nov. 4, 2022.

(51) Int. Cl. G06F 21/64; G06F 21/60

(52) U.S. Cl. CPC G06F 21/64; G06F 21/602

(57) ABSTRACT

Procedures, methods, architectures, apparatuses, systems, devices, and computer program products directed to in connection with application-aware computing and communication management in a blockchain system are provided. Among the methods is a method that may include transmitting a first transmission to a processing device of a distributed ledger, wherein the first transmission comprises information indicating collective data interest plan (CDIP) content, including filters for filtering transactions for the first device and a second device; receiving a second transmission from the processing device, wherein the second transmission comprises information indicating a summary digest for multiple filtered transactions; generating multiple transaction set units (TSUs); and transmitting, to the processing device, information indicating to the processing device to transmit to the second device one or more of the multiple TSUs.

### CROSS-REFERENCE TO RELATED APPLICATION(S)

This application claims priority to and the benefit of U.S. Provisional Application No. 63/422,927 filed in the U.S. Patent and Trademark Office on Nov. 4, 2022, the entire contents of which being incorporated herein by reference as if fully set forth below in their entirety and for all applicable purposes.

### SUMMARY

Embodiments disclosed herein are related to methods, apparatuses, and procedures for application-aware computing and communication management in a blockchain system.

In one embodiment, a method implemented in a first device (e.g., a wireless transmit and/or receive unit (WTRU) for wireless communications) includes transmitting a first transmission to a processing device of a distributed ledger, and the first transmission comprises information indicating collective data interest plan (CDIP) content, including filters for filtering transactions for the first device and a second device; receiving a second transmission from the processing device, and the second transmission comprises information indicating a summary digest for multiple filtered transactions; generating multiple transaction set units (TSUs); and transmitting, to the processing device, information indicating to the processing device to transmit to the second device one or more of the multiple TSUs.

In one embodiment, a method implemented in a first device (e.g., a WTRU for wireless communications) includes transmitting a first transmission to a processing device of a distributed ledger, and the first transmission comprises information indicating CDIP content, including filters for filtering transactions for the first device and a second device; receiving a second transmission from the processing device, and the second transmission comprises information indicating a summary digest for multiple filtered transactions; generating multiple TSUs, for example, each of first one or more of the TSUs comprises first one or more of the filtered transactions indicated in the summary digest for the first device or the first and second devices, and each of second one or more of the TSUs comprises second one or more of the filtered transactions indicated in the summary digest for the second device; and transmitting, to the processing device, information indicating to the processing device to transmit to the second device at least one of the first one or more of the TSUs and the second one or more of the TSUs, and at least one of the first one or more of the TSUs and the second one or more of the TSUs is transmitted using a respective resource assignment based on priorities associated with 1) the first one or more of the TSUs and the second one or more of the TSUs, and/or 2) the first and/or second devices.

In one embodiment, a first device (e.g., a WTRU for wireless communications) comprises circuity, including a processor, a transmitter, a receiver, and/or memory is provided. The first device (e.g., the WTRU) is configured to transmit a first transmission to a processing device of a distributed ledger, and the first transmission comprises information indicating CDIP content, including filters for filtering transactions for the first device and a second device; to receive a second transmission from the processing device, and the second transmission comprises information indicating a summary digest for multiple filtered transactions; to generate multiple transaction set units (TSUs), for example, each of first one or more of the TSUs comprises first one or more of the filtered transactions indicated in the summary digest for the first device or the first and second devices, and each of second one or more of the TSUs comprises second one or more of the filtered transactions indicated in the summary digest for the second device; and to transmit, to the processing device, information indicating to the processing device to transmit to the second device at least one of the first one or more of the TSUs and the second one or more of the TSUs, and at least one of the first one or more of the TSUs and the second one or more of the TSUs is transmitted using a respective resource assignment based on priorities associated with 1) the first one or more of the TSUs and the second one or more of the TSUs, and/or 2) the first and/or second devices.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures and the detailed description are not to be considered limiting, and other equally effective examples are possible and likely. Furthermore, like reference numerals (“ref.”) in the Figures indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a block diagram illustrating example structures of blocks of a blockchain system, according to one or more embodiments;

FIG. 3 is a block diagram illustrating an example of a local copy of a blockchain header of a Light blockchain node (BCN), according to one or more embodiments;

FIG. 4 is a block diagram illustrating example interactions between a Light BCN and a Full BCN, according to one or more embodiments;

FIG. 5 is a block diagram illustrating an example of blockchain data verification, according to one or more embodiments;

FIG. 6 illustrates a blockchain-enabled social data sharing use case, according to one or more embodiments;

FIG. 7 illustrates a use case related to a network measurement data integrity, according to one or more embodiments;

FIG. 8 is a block diagram illustrating example interactions between a Light BCN and a Full BCN, according to one or more embodiments;

FIG. 9 is a block diagram illustrating an example architecture of an application-aware blockchain operation optimizer, according to one or more embodiments;

FIG. 10 illustrates an example procedure for enabling and/or carrying out CDIP creation and/or DCBC registration, according to one or more embodiments;

FIG. 11 illustrates an example procedure for enabling and/or carrying out CDIP creation and/or DCBC registration, according to one or more embodiments;

FIG. 12 illustrates an example procedure for determining delivery priority according to an ABOO-dominant approach;

FIG. 13 illustrates an example procedure for determining delivery priority according to a Full-BCN-dominant approach, according to one or more embodiments;

FIG. 14 illustrates an example procedure for a TSU delivery solution (TDS) determination, according to one or more embodiments;

FIG. 15 illustrates an example procedure for collaborative TDS execution, according to one or more embodiments;

FIG. 16 illustrates an example of an ABOO, according to one or more embodiments;

FIG. 17 illustrates an example of a 3GPP SA2 embodiment;

FIG. 18 illustrates an example procedure for enabling and/or carrying out CDIP creation and/or DCBC registration, according to one or more embodiments;

FIG. 19 illustrates an example SA6 embodiment;

FIG. 20 illustrates an example SA6 embodiment using PIN architecture;

FIG. 21 illustrates an example procedure for enabling and/or carrying out CDIP creation and/or DCBC registration, according to one or more embodiments; and

FIG. 22 illustrates an example of an ETSI PDL embodiment.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

One or more of the following abbreviations and/or corresponding terms may be used herein.
3GPP 3rd Generation Partnership Project
5G Fifth (5^{th}) Generation
5GC 5G Core Network
5GS 5G System
6G Sixth (6^{th}) Generation
6GS 6G System
ABOO Application-aware Blockchain Operation Optimizer
AF Application Function
AMF Access and Mobility Management Function
ARPS Application Registration Platform Service
App Application
BCN Blockchain Node
CDIP Collective Data Interest Plan
CPE Customer-Provided Equipment
DC Data Consumer
DCBC DC Blockchain Capability
DGP DC Group Policies
DGSC DC Group Smart Contract
DLT Distributed Ledger Technology
DN Data Network
DP Data Provider
E2E End-to-End
eRG Evolved Residential Gateway
ETSI European Telecommunications Standards Institute
HT Helper Team
IBDI Individual Blockchain Data Interest
IoT Internet-of-Things
IPFS The InterPlanetary File System
ISG Industry Specification Group
ITDPL Individual TSU Delivery Priority List
NEF Network Exposure Function
NF Network Function
NG-RAN Next-generation RAN
NRF Network Repository Function
P2P Peer-to-Peer
PCF Policy Control Function
PDL Permissioned Distributed Ledger
PDU Protocol Data Unit
PEMC PIN Element with Management Capability
PEGC PIN Element with Gateway Capability
PIN Personal IoT Network
PINE PIN Element
PoW Proof-of-Work
RAN Radio Access Network
RPS Registration Platform Service
RRC Radio Resource Control
RSU Road-Side Unit
SA Service Architecture
SD Summary Digest
SFO Service Fee Offer
SFOL SFO List
SFQ Service Fee Quote
SMF Session Management Function
TDPL TSU Delivery Priority List
TDS TSU Delivery Solution
TL TSU List
TSU Transaction Set Unit
UDM Unified Data Management
UDR Unified Data Repository
UDSF Unstructured Data Storage Function
UE User Equipment
UPF User Plane Function

### Example Communications System

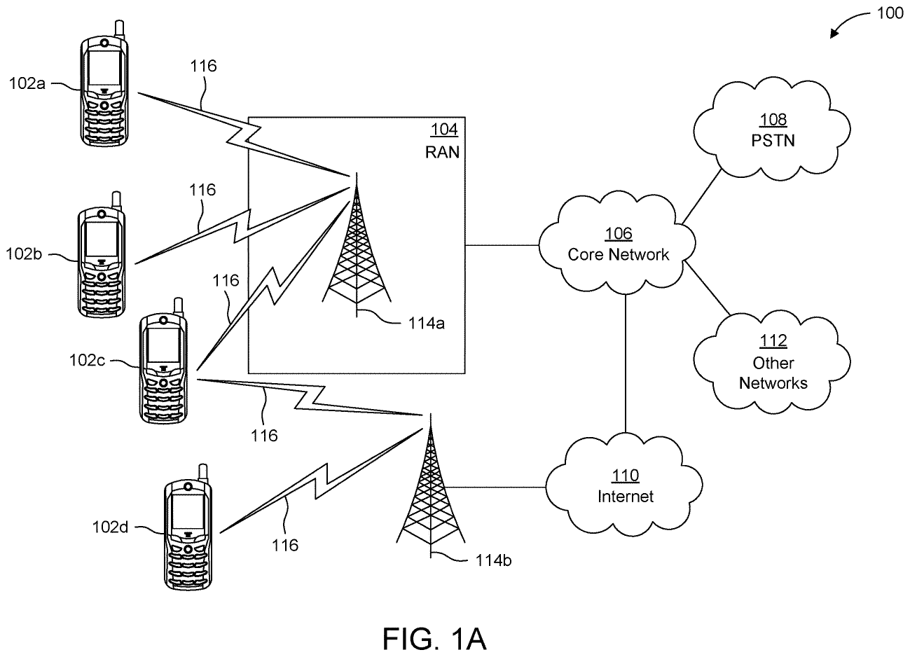

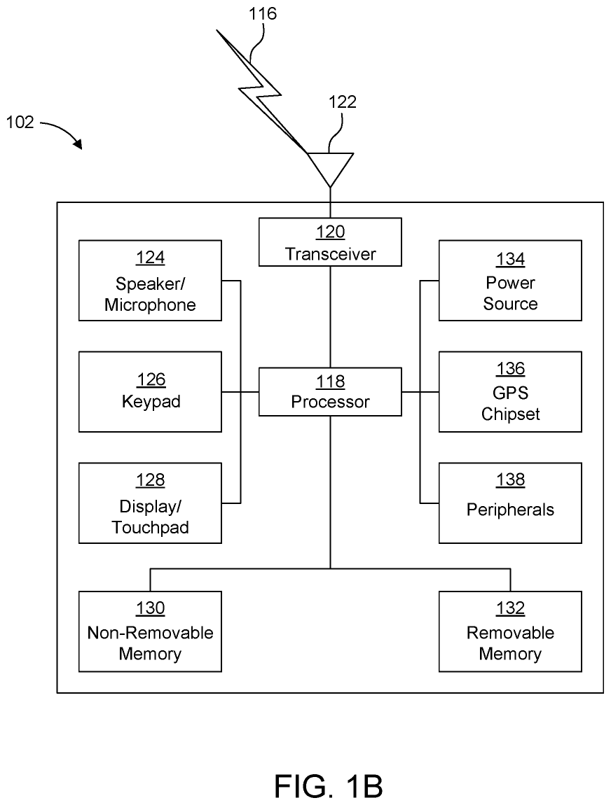

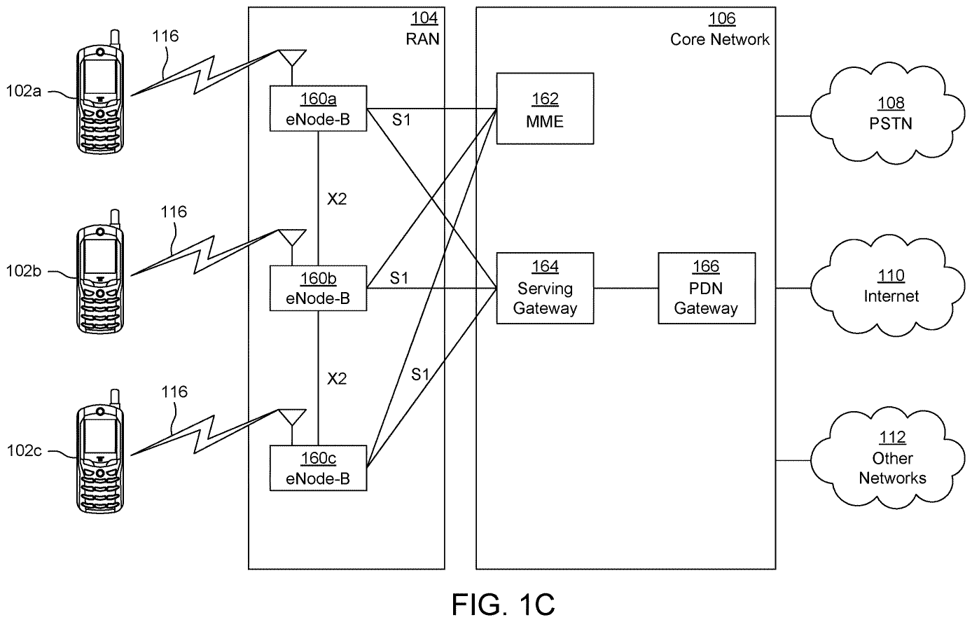

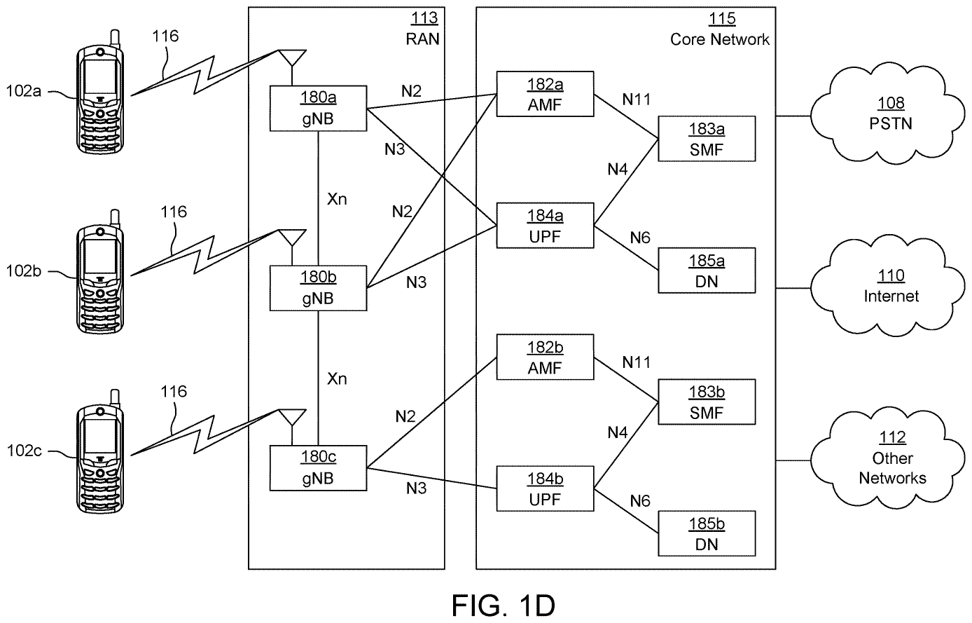

The methods, apparatuses and systems provided herein are well-suited for communications involving both wired and wireless networks. Wired networks are well-known. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a diagram of an example communications system 100 in which one or more disclosed embodiments may be implemented. Example communications system 100 is provided for the purpose of illustration only and is not limiting of the disclosed embodiments. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronic device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. Example WTRU 102 is provided for the purpose of illustration only and is not limiting of the disclosed embodiments. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. For example, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules/units that provide additional features, functionality and/or wired or wireless connectivity. For example, the peripherals 138 may include an accelerometer, an e-compass, a satellite transceiver, a digital camera (e.g., for photographs or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram of the RAN 104 and the CN 106 according to another embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The core network 106 shown in FIG. 1C may include a mobility management gateway (MME) 162, a serving gateway (SGW) 164, and a packet data network (PDN) gateway 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The SGW 164 may be connected to each of the eNode-Bs 160a, 160b, 160c in the RAN 104 via the SI interface. The SGW 164 may generally route and forward user data packets to/from the WTRUs 102a, 102b, 102c. The SGW 164 may also perform other functions, such as anchoring user planes during inter-eNode-B handovers, triggering paging and/or mobile termination when DL data is available for the WTRUs 102a, 102b, 102c, managing and storing contexts of the WTRUs 102a, 102b, 102c, and the like.

The SGW 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to a Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 180b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different packet data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Representative Blockchain Technology

Blockchain technology jointly uses and builds on top of various existing techniques, such as cryptography, hashing, Merkle tree, distributed ledgers, peer-to-peer (P2P) networking and consensus protocols. Blockchain technology innovatively combines such existing technologies to enable a system that can provide advanced features such as decentralization, immutability, transparency, and security.

A blockchain system has various advantages over existing technologies, such as e.g., supporting data exchange between untrusted entities, supporting decentralization and data immutability, native incentivization, etc. Data sharing between one or more data providers (DPs) and one or more data consumers (DCs) via a blockchain system may be carried out, used, defined, configured and/or determined. In various embodiments, e.g., data may be written into a blockchain system by the DPs and then accessed and/or consumed by the DCs. The various advantages include (e.g., in addition to supporting decentralization, immutability, transparency, and security) other application-layer advanced features and/or benefits. The application-layer advanced features and/or benefits may include, e.g., blockchain may decouple DPs and DCs, and support for asynchronized and/or decentralized data exchanging. Also, data stored in a blockchain may be leveraged by multiple DCs at the same time.

A blockchain system is one in which blockchain technology is used. Applications using and/or supported by a blockchain system are referred to as blockchain applications. A blockchain system is underpinned by one or more underlying blockchain networks. Each blockchain network may include a plurality of (e.g., many) participating blockchain nodes (BCNs). Some of the BCNs (referred to herein as “Full BCNs”) may host instances of blockchain data (which are often large in size, e.g., more than 400 GB for a Bitcoin node). Each full BCN, for example, may host one or more distributed blockchains (a form of distributed ledgers). Each Full BCN may include a component (“communication component”) and may use communication component to carry out communication and/or exchanging data with other BCNs. For example, each Full BCN may use the communication component to broadcast blockchain transactions and/or blocks using P2P networking. At least some of the full BCNs may be mining BCNs. Each mining BCN may include a mining component and may use the mining component to participate in and conduct consensus processes/protocols with other BCNs of the blockchain network to reach distributed trust and data consensus without relying on a centralized party. A mining BCN (e.g., each mining BCN) may use the mining component to group (e.g., many) newly generated and pending transactions together, calculate a hash of a previously-confirmed block, and calculate a hash of all included transactions in connection with generating a new block. A blockchain transaction may be any of a digital representation of a real-world transaction, a digital record of physical assets, a digital record of a physical event, a digital record of any action in an information system, a digital payment and a digital smart contract. A block groups multiple blockchain transactions together. A blockchain is a data structure to chain a growing number of blocks.

Some of the other BCNs (referred to herein as “Light BCNs”) may connect to the blockchain network to obtain blockchain data from the Full BCNs. A Light BCN may be, for example, a UE or other device (e.g., as a DC) that does not host local copies of blockchain data. A Light BCN may lack sufficient storage space and/or processing resources for hosting local copies of blockchain data. Alternatively, a Light BCN may have sufficient storage space and/or processing resources for hosting local copies of blockchain data, but not be configured to and/or not allocate storage space and/or processing resources for hosting local copies of blockchain data.

A Light BCN may include a communication component and may use communication component to carry out communication and/or exchanging data with other BCNs. A Light BCN may possess and/or maintain a local copy of a blockchain header. The blockchain header may include only headers of blocks. The Light BCN (e.g., as a DC) may connect to a Full BCN and may deploy filter to the Full BCN a filter (e.g., having filter criteria thereof) based on one or more data interests of the Light BCN. As used herein, data interests refer to blockchain data (e.g., transaction records) matching or according to one or more (e.g., various) criteria and/or attributes (“data-interest criteria”). All or some of the data interests may refer to blockchain data that exists in the blockchain data hosted by the Full BCN at a time of deployment of the filter. Alternatively, and/or additionally, all or some of the data interests may refer to blockchain data added to the blockchain data hosted by the Full BCN after deployment of the filter. Alternatively, and/or additionally, all or some of the data interests may refer to blockchain data that is not available from the blockchain data hosted by the Full BCN.

Each of the data interests may refer to blockchain data (e.g., transaction records) matching or according to a set, collection or group (collectively “set”) of data-interest criteria. For example, a first of the data interests may refer to a first set blockchain data (e.g., transaction records) matching or according to a first set of data-interest criteria, a second of the data interests may refer to a second set blockchain data (e.g., transaction records) matching or according to a second set of data-interest criteria (e.g., different than the first set of data-interest criteria), and so on. The sets of data-interest criteria may be mutually exclusive. Alternatively, at least some of the sets of data-interest criteria may have some of the same data-interest criteria.

The Full BCN may apply the filter to the hosted blockchain data and may send to the Light BCN (e.g., as a DC) the blockchain data (e.g., only the blockchain data) relevant to the data interests of the Light BCN. The Light BCN (e.g., as a DC) may receive the blockchain data sent from the Full BCN and may conduct blockchain-related processing on the received blockchain data, such as, for example, perform blockchain data verifications on the received blockchain data (e.g., to ensure the received data were recorded in the blockchain). The Light BCN may use the blockchain header to verify whether the received blockchain data/transactions are recorded in a (e.g., the longest) chain of the blockchain system (e.g., in instances in which only the longest chain is regarded as the valid version and/or main chain of the blockchain system).

When DCs interact with blockchain systems, it involves certain computing and communication overhead. Embodiments disclosed herein may optimize/reduce system-wide blockchain-related computing/communication overhead, e.g., by enabling collaborative blockchain data access/processing among multiple DCs. Embodiments disclosed herein may address one or more of the following issues.

Issue 1: Lack of coordination between DCs who share the same blockchain data interests. DCs interact with blockchain system individually without any collaboration/coordination, which may lead to repetitive operation costs in terms of computing/communication overhead on the blockchain-related processing.

Issue 2: On the Full BCN side, the transaction filtering operation only takes into consideration “static” DC specified data types and does not consider various real-time dynamics/changes (such as limited network resources and conditions) and the potential competition/contentions among DCs for those limited resources.

Issue 3: Existing blockchain-related operations/processing do not support capability/capacity sharing and helping between different DCs.

Disclosed herein are blockchain system concepts, which use the classical Bitcoin system and/or Ethereum as examples. However, the various embodiments may be applicable and/or may apply to any blockchain-related processing (e.g., that has costs in terms of computing/communication overhead) of any type of blockchain system.

For simplicity of exposition, the terms “blockchain technology” are used herein. It should be understood that such terms also represent much broader distributed ledger technology. As such, the various embodiments are applicable to any specific blockchain technology and/or distributed ledger technology.

### Representative Block Structure

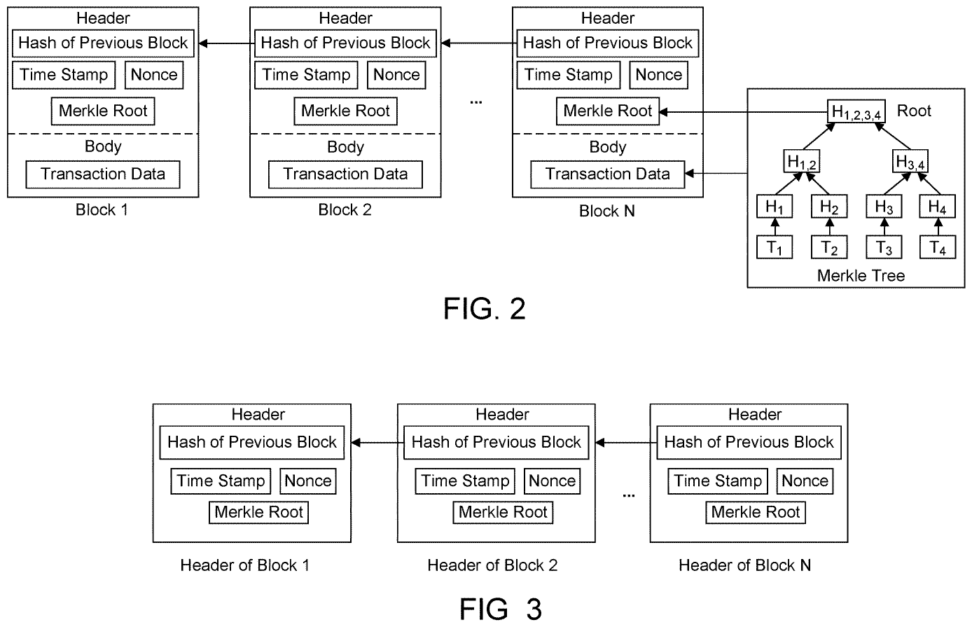

FIG. 2 is a block diagram illustrating example structures a plurality of blocks of a blockchain system. As shown, the structure (“block structure”) of any block N may include a plurality of parts. The plurality of parts may include a header part (or simply “header”) and a body part (or simply “body”).

The header (“block header”) may include metadata of the block, a time stamp, a nonce and a Merkle root. The time stamp may indicate when (e.g., a time at which) the block was created. The nonce may be used in connection with (e.g., when) creating a block and/or verifying a valid block). The metadata may include a hash (e.g., a 256-bit hash) of a block header of an immediately preceding block (“predecessor block”). Other than for an initial block of a blockchain, which may be referred to as a genesis block and does not have a predecessor block, the hash points to a predecessor block. In particular, a successor block may store a hash of a predecessor block (using a hash pointer), which realizes the immutability and anti-tamper characteristic of a blockchain system. For example, any changes in a predecessor block results in the hash pointer stored in its successor block being invalid, which can be easily detected.

The body (“block body”) may include (store) transaction data. The transaction data may include one or more (typically many) blockchain transactions. The body usually occupies more storage space than the header. A Merkle tree may be used to summarize (e.g., efficiently summarize) the transactions included/stored in a block.

The Merkle tree may include, as leaf nodes, hashes of the transactions stored in the block body (e.g., one hash/leaf node for each of the transactions stored in the block body). As shown in FIG. 2, the Merkle tree has a plurality of tree leaves, where, for example, a first hash, H₁, of a first transaction, T₁, that is stored in a block body is one of the leaf nodes and a second hash, H₂, of a second transaction, T₂, that is stored in the block body is another one of the leaf nodes. The Merkle tree may include non-leaf nodes, including a root node (“Merkle root”). Each of the non-leaf nodes may be a concatenation (or other combination) of hashes of child tree nodes. For example, the Merkel tree may include a first non-leaf node, H_{1,2}, that is a concatenation of child leaf nodes H₁ and H₂, a second non-leaf node, H_{3,4}, that is a concatenation of child leaf nodes H₃ and H₄, and a Merkle root, H_{1,2,3,4}, that is a concatenation of child non-leaf nodes, H_{1,2}, and H_{3,4}. The Merkle root, e.g., H_{1,2,3,4}, or information indicating the Merkle root (collectively “Merkle root information”) is stored in the block header. Including the Merkle root information in the block header is done for various reasons. For example, (i) any modification on a transaction changes a value of the Merkle root, and in turn, results in a change in the hash of the block header, which can be easily detected (as detailed supra) and (ii) a Light BCN may verify (e.g., efficiently verify) whether a received transaction is included in the blockchain system based on the Merkle root information stored in the block header. With respect to the latter, a Light BCN need not possess a full block (header+body) and may possess a block header of a longest chain in the network and some of the transactions relevant to it (e.g., a Light BCN installed on Mary's cellphone may store a blockchain header copy and transactions related to Mary).

### Representative Light Blockchain Node

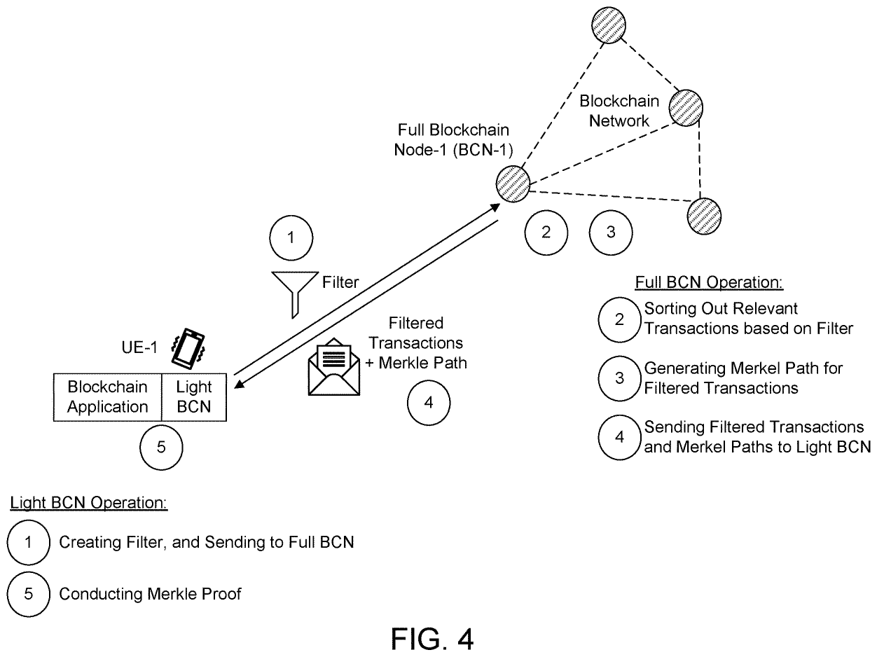

FIG. 3 is a block diagram illustrating an example of a local copy of a blockchain header that a Light BCN may possess and/or maintain. The blockchain header, as compared to corresponding blockchain data hosted by a Full BCN, may use and/or require less (e.g., significantly less) storage space and computing resources. For example, a full node in the Bitcoin network requires at least 415 GB (as of Jul. 10, 2022) of storage space to keep a local copy. It is often the case that a Full BCN node may be deployed on a powerful computing host, e.g., deployed in a cloud. In comparison, a Light BCN may require tens of MB (e.g., around 40-50 MB in the Bitcoin system) to store a blockchain header.

A Light BCN may serve a particular client application (called blockchain application) that needs to interact with the blockchain system. Therefore, a Light BCN usually only needs to receive and store the user or application-relevant transactions received from Full BCNs.

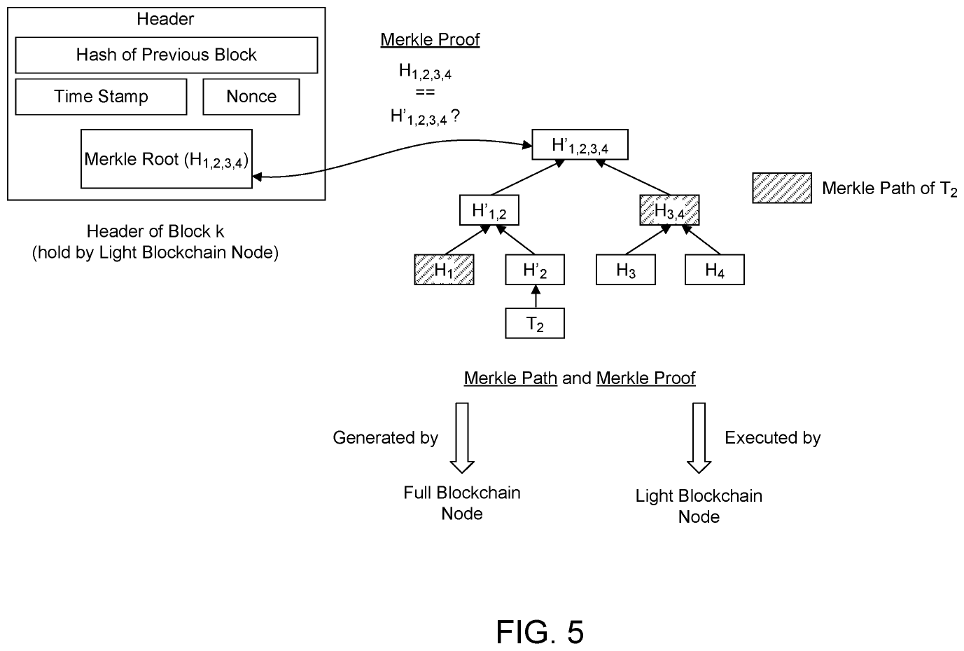

FIG. 4 illustrates example interactions between a Light BCN and a Full BCN (“Full BCN-1”) of a network of Full BCNs. A UE (shown as “UE-1”) may host a blockchain application to interact with a blockchain network. For example, the UE may interact with a blockchain network via the blockchain application to store data in the blockchain system and/or to retrieve/receive data from the blockchain system. The UE operating as a Light BCN (e.g., using functionality installed/configured on the UE) may communicate with Full BCNs in the blockchain network. For simplicity of exposition herein, a UE operating as a Light BCN may be referred to herein as simply a Light BCN. The Light BCN and the Full BCN-1 may conduct certain blockchain-related computing/processing during or in connection with their interactions. The Light BCN and Full BCN may use on a communications system, such as the communications system 100 (FIG. 1A-1C), in connection with exchanging blockchain-related messages/data.

Referring to FIG. 4, an example workflow of interactions between the Light BCN and the Full BCN is shown. The workflow may include five components (“WFC 1-5”).

WFC 1. The Light BCN may be configured to serve the hosted blockchain application. The Light BCN may connect to the BCN-1. The Light BCN may create a transaction filter based on data-interest criteria for data interests of the hosted blockchain application. The Light BCN may deploy the filter to the Full BCN-1. A bloom filter-based approach (e.g., as in the existing Bitcoin system) may be used to implement filtering at the Full BCN-1 (“Full-BCN-side filtering”). Alternatively, the Light BCN might not deploy the filter to the Full BCN-1 and may use the filter to perform filtering (“Light-BCN-side filtering) of digests of new blocks sent (e.g., periodically) from the Full BCN-1 and received by the Light BCN. The Light BCN and may use the filter to perform the Light-BCN-side filtering of the digests of new blocks.

The Light BCN might not deploy the filter to the Full BCN-1, e.g., based on one or more privacy reasons, issues, concerns, rules, restrictions (legal or otherwise), requirements (legal or otherwise), etc. For example, the data interests on which the filter is based may be subject to a privacy requirement that restricts exposure of the data interests (e.g., to the Full BCN-1, one or more of the other Full BCNs, and/or at all) and the Light BCN may forego deploying the filter to the Full BCN (or at all) based on and/or responsive to the privacy requirement and/or may use the filter to perform filtering of digests sent (e.g., periodically) from the Full BCN-1 and received by the Light BCN. Each of the digests may include (i) one or more blocks previously provided to the Light BCN (“previously-provided blocks”), (ii) one or more blocks not previously provided to the Light BCN (“newly-provided blocks”), or (iii) one or more newly-provided blocks and one or more previously-provided blocks.

In various embodiments, the Light BCN might not create (or may forego creating) a transaction filter for deployment to the Full BCN-1 (and/or any other Full BCN of the network of Full BCNs) and may perform Light-BCN-side filtering of the digests of new blocks, locally (at the UE), based on the data-interest criteria for the data interests of the hosted blockchain application. In various embodiments, the Light BCN may request and/or instruct the Full BCN to include only entire blocks in any one or more (e.g., each/all) of the digests.

In various embodiments, the Light BCN may request and/or instruct the Full BCN to include only blocks having a minimum number of transactions (where the minimum number is less than all transactions) in any one or more (e.g., each/all) of the digests. In various embodiments, the Light BCN may request and/or instruct the Full BCN to include only a combination of entire blocks and blocks having a minimum number of transactions (where the minimum number is less than all transactions) in any one or more (e.g., each/all) of the digests. The Full BCN may provide the entire blocks and/or the blocks having a minimum number of transactions) in the digests as requested or instructed. Alternatively, the Full BCN might not provide digests with the entire blocks and/or blocks having a minimum number of transactions as requested or instructed, and may provide the digests based on another criteria (e.g., based on best efforts). Among various reasons for having the Full BCN provide only entire blocks and/or blocks having the minimum number of transactions (where the minimum number is less than all transactions) is that doing so prevents or limits likelihood of the Full BCN determining and/or inferring the data interests of the hosted blockchain application based on the blocks provided to the Light BCN (e.g., provides another layer of protection against exposing the data interests).

Although Full-BCN-side filtering and Light-BCN-side filtering may be equally applicable in various embodiments of the disclosures herein, for convenience and simplicity of exposition, the Full-BCN-side filtering is assumed in the disclosures herein unless otherwise indicated or apparent from accompanying disclosures.

WFC 2. In various embodiments, the Full BCN-1 may receive one or more new blocks to append to the blockchain and may append the new blocks to the blockchain. The full BCN-1 may perform filtering of the new blocks using the filter, where the output of which indicates blockchain data/transactions relevant to the data interests of the of the hosted blockchain application. The full BCN-1 may replicate or otherwise make copies of the indicated blockchain data/transactions for delivery to the Light BCN.

In various embodiments, a Light BCN may synchronize data with the Full BCN-1 (or vice versa), e.g., based on and/or responsive to (i) the Light BCN connecting to the blockchain network for a first time, (ii) the Light BCN and/or the Full BCN-1 being offline for some (e.g., (pre)configured) amount of time and/or (iii) interaction inactivity for some (e.g., (pre)configured) amount of time. The Light BCN may be (and/or considered to be) offline when not connected to the blockchain network, e.g., following a disconnection from the blockchain network. The Full BCN-1, as part of synchronizing with the Light BCN, may determine historical blockchain data/transactions relevant to the data interests of the of the hosted blockchain application (e.g., based on a newly deployed filter and/or a previously deployed filter), replicate or otherwise make copies of the determined historical blockchain data/transactions, for delivery to the Light BCN. In various embodiments, the Light BCN and/or the Full BCN-1 may initiate data synchronization. For example, the Light BCN (and/or the Full BCN-1) may send to the Full BCN-1 (and/or the Light BCN) information indicating a request or command (e.g., a “getData” command) to initiate and/or carry out data synchronization. The Full BCN may send to the Light BCN the copies of the determined historical transactions based on and/or responsive to the request or command to initiate and/or carry out data synchronization.

Although new block filtering and historical block/transaction filtering may be equally applicable in various embodiments of the disclosures herein, for convenience and simplicity of exposition, the new block filtering is assumed in the disclosures herein unless otherwise indicated or apparent from accompanying disclosures.

WFC 3. In various embodiments, the Light BCN (and/or the UE) might not trust the Full BCN-1. The Full BCN-1 may provide information indicating certain evidence (e.g., Merkle Path) to the Light BCN. The Light BCN may conduct blockchain data verification of the copies of the blockchain data/transactions received from the Full BCN-1 using the indicating certain evidence (e.g., Merkle Path) to determine (e.g., ensure) the data (included in the transactions) received from the Full BCN-1 are recorded/included in the blockchain system.

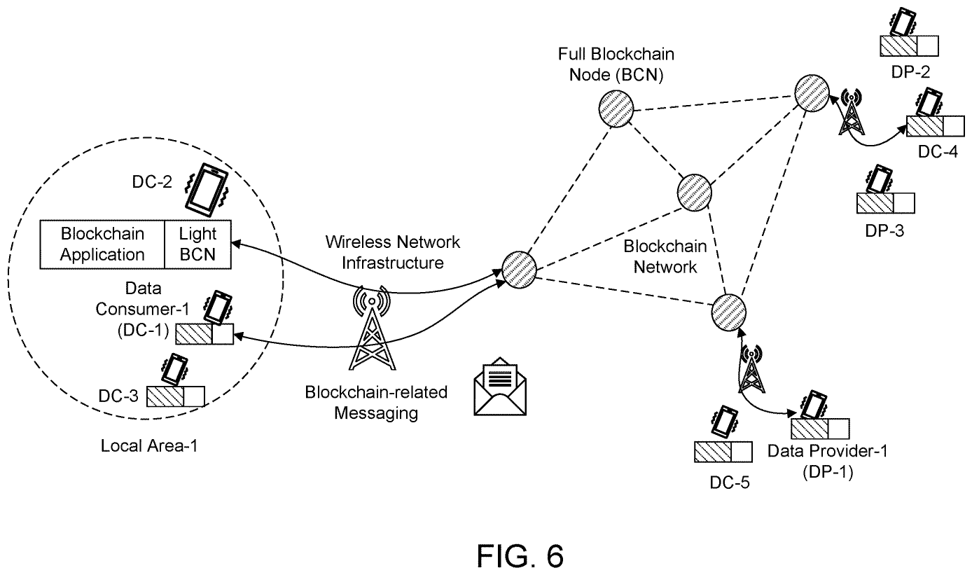

FIG. 5 is block diagram illustrating an example of blockchain data verification of blockchain data/transactions received by a Light BCN from a Full BCN. The Light BCN may carry out the blockchain data verification, e.g., based on, e.g., a comparison of information stored in the blockchain headers and evidence determined from information stored in block bodies corresponding to the blockchain headers.

The Full BCN-1 may receive a new block to be recorded in the blockchain system after a consensus process. The block may include a Transaction T₂. The Transaction T₂ may be, for example, one of one or more relevant transactions to be sent to the Light BCN. H₂ is a hash of Transaction T₂. The Merkle Path of T₂ is defined as {H₁, H_{3,4}}.

WFC 4. Referring again to FIG. 4, the Full BCN-1 may send the copies of the blockchain data/transactions (e.g., including Transaction T₂) and the corresponding Merkel Paths to the Light BCN.

WFC 5. The Light BCN may store headers of blocks of a chain (e.g., the longest chain) in the network. The Light BCN (and/or the UE) might not trust the Full BCN-1. The Light BCN (and/or the UE) may verify whether data included in the received transactions (e.g., Transaction T₂) are recorded in the blockchain system. The blockchain data verification process can be realized using a Merkle Proof. With reference to FIG. 5, a Merkle Path generated by the Full BCN-1 may be sent from the Full BCN-1 and received by the Light BCN. The Light BCN may carry out blockchain data verification based on the Merkle Proof, the Merkle Path and a Merkel Root included in the blockchain headers.

By way of example, the Light BCN may use the received Merkle Path to calculate a tree root, H′_{1,2,3,4}. The Light BCN may receive a blockchain header of a corresponding Block k containing Transaction T₂ from the Full BCN-1. The blockchain header may include a true value of the Merkle Root H_{1,2,3,4}. The Light BCN may perform the blockchain data verification of Transaction T₂, e.g., based on the Merkle Proof and by determining whether the tree root H′_{1,2,3,4} is equal to the Merkle Root H_{1,2,3,4}. A determination that the tree root H′_{1,2,3,4} is equal to the Merkle Root H_{1,2,3,4} indicates that Transaction T₂ is included in the header of Block k. The Light BCN may determine whether the locally stored blockchain headers (e.g., the blockchain headers of longest chain) are up to date via (e.g., periodically) querying other peers (Full BCNs) in the network and a determination that the locally stored blockchain headers (e.g., the blockchain headers of longest chain) are up to date may verify that the header of Block k is included in up-to-date blockchain headers (e.g., the blockchain headers of longest chain) and, in turn, indicates the Transaction T₂ is recorded in the up-to-date blockchain headers (e.g., the blockchain headers of longest/main chain)). The Light BCN may choose to wait for some time, e.g., after six additional new blocks are appended after Block k, which can be regarded as the final confirmation. The Light BCN may determine that the locally stored blockchain headers (e.g., the blockchain headers of longest chain) are not up to date and may update accordingly via (e.g., periodically) querying other peers (Full BCNs) in the network. The Light BCN may determine the header of Block k is included in the updated (e.g., up-to-date) blockchain headers (e.g., the blockchain headers of longest chain) and, in turn, the Transaction T₂ is recorded in the updated (e.g., up-to-date) blockchain headers (e.g., the blockchain headers of longest/main chain).

Currently, within 3GPP, the Service Architecture Working Group 6(SA6 ) is pushing the boundaries of 3GPP beyond the traditional system and radio standards. The 3GPP SA6 Working Group has gradually expanded its activities for the standardization of new vertical applications within the 3GPP ecosystem and to promote the adoption of 3GPP technology across a variety of industries. In particular, some of the activities are related to how to adopt edge computing capabilities.

A permissioned distributed ledger (PDL) may be one various types of distributed ledger systems applicable to various embodiments disclosed herein The PDL, might (or is) not publicly accessible. Only nodes/entities authorized to use the PDL may join the PDL network. ETSI Industry Specification Group for Permissioned Distributed Ledgers (ISG PDL) focuses on standardization on PDL, and the PDL reference architecture may include one or more PDL applications, a PDL platform services layer and a distributed ledger technology (DLT) layer.

The PDL applications may be applications that may use PDL technology. The PDL platform services layer may support various types of applications. The PDL platform service layer may provide useful services for applications. An application may leverage (e.g., use, subscribe to, etc.) services provided by the PDL platform service layer, and the use of the PDL platform service layer may reduce the application's complexity, accelerate application development and deployment, and/or increase interoperability. The DLT layer may be an implementation of a PDL using a specific type of DLT.

### Representative Use Case 1—Blockchain-Enabled Social Data Sharing

People are relying more and more on their mobile phones or UEs (e.g., via applications installed on the UEs) for social interactions and UEs may generate various data to be shared during social interactions. For example, some UEs (as DPs) may generate certain data that may be shared with other UEs (as Data DCs).

Tampering of data (e.g., chat history or other important data) cannot be fully avoided in existing social network platforms (such as, Facebook, Twitter, etc.). The social network platforms often claim that user-sensitive data (e.g., chat history) is never stored on their servers (unless users require to do so), and a result of which is that users have 100% privacy. However, a consequence of not storing user-sensitive data is a lack of traceability. A common anti-tampering measure that users resort to for preservation of data/evidence is to use screen capturing tools of the UE to capture and store snapshots (e.g., images/video) of the data, e.g., contemporaneous with the posting or otherwise disseminating the data. Although tolerable for simple scenarios (e.g., chat history backup) or non-sensitive multimedia data, such anti-tampering measure cannot fully realize data immutability.

Data trading between/among untrusted people on a social network/platform has risks. For example, person A may have to pre-assume that person B can be trusted when A and B are going to conduct certain data trading. When disputes happen, often the platform providers (e.g., Facebook, Twitter) and/or other central authorities insert themselves as arbiters of arbitration of such disputes.

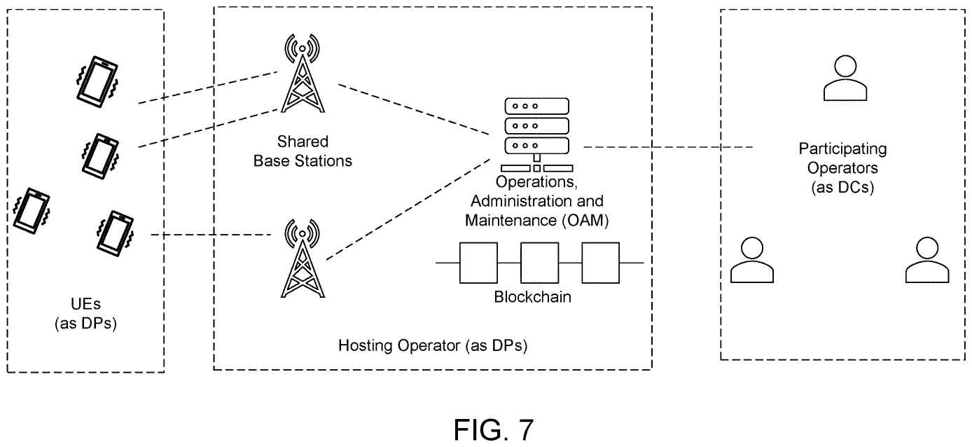

Blockchain may be leveraged as an infrastructure (e.g., a default, a preferred, etc., infrastructure) for next-generation social networks and it may natively support data integrity, data traceability, and data immunizability. With reference to FIG. 6, a DP (“DP-1”) may write some data into a blockchain. Pursuant to Full BCN filtering (and/or Light BNC filtering), the data may match and/or may be in accordance with data interests of a plurality of DCs in a locality (e.g., DC-1. DC-2, DC-3, etc.), and be delivered to the plurality of DCs. Implementing blockchain and the embodiments disclosed herein may provide value and benefits to social network platforms and/or providers. Among the benefits of implementing blockchain may be that different/competing problems may be solved and/or different/competing goals may be achieved by implementing one or more of the disclosed embodiments disclosed herein. For example, even within a single social network platform (such as Facebook), a goal of protecting/respecting user privacy may be in conflict with a goal of data/system traceability. By implementing blockchain and embodiments disclosed herein, the social network platforms and/or providers may to claim that they never store user-sensitive data (e.g., chat history) on their servers so that users still have 100% privacy and at the same time, hashes of various social/user data may be stored in the blockchain. By doing so, no valuable/sensitive information can be easily derived from the hashed data stored in the blockchain so that user privacy is still well protected. Storing the hashes of the social data in the blockchain may provide data immutability and data traceability for certain application scenarios (e.g., users may verify whether a corresponding chat has been tampered by any party).

Another application scenario is that the blockchain system may act as the underlying shared database system for multiple social network platforms. A smart contract built on top of the blockchain may be used to facilitate cross-platform data sharing and trading without the need for a central authority (e.g., Twitter User A wants to borrow/buy a photo created/posted by a Facebook User B). The smart contract and native payment support of the blockchain system may enable data trading between users of different platforms without relying on traditional cross-platform payment processing and the blockchain traceability may be beneficial for enforcing cross-platform intellectual property protection).

### Representative Use Case 2—Network Measurement Data Integrity

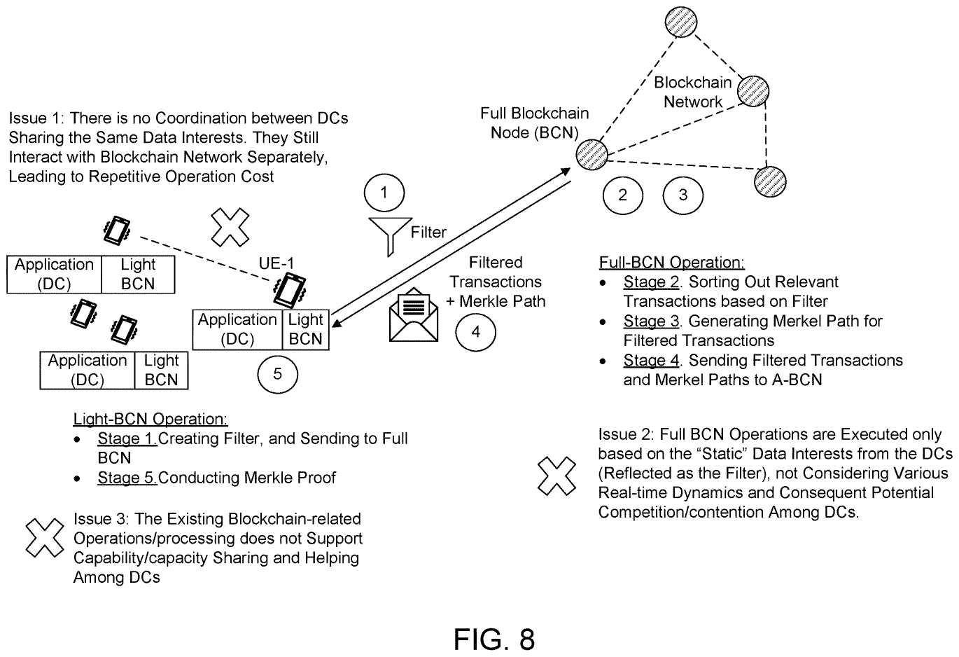

FIG. 7 illustrates a use case related to a network measurement data integrity. With reference to FIG. 7, a RAN infrastructure of a hosting operator may be shared with other participating operators. For example, various network performance and/or measurement data may be created by different entities as DPs (such as UEs, base stations, and network functions of the hosting operator) during operation. The network performance and/or measurement data may include UE real-time channel status, network load information, base station performance, service quality, etc. Such performance and/or measurement data may be among the data interests of the participating operators as DCs. The performance and/or measurement data may be among the data interests of the participating operators as DCs, for example, because the participating operators as DCs may use the performance and/or measurement data to determine current network status and/or make adjustment for their services.

At least some of the operators might not (e.g., do not) trust each other. For example, a local small operator may temporally share its RAN with another small operator without any prior-established collaboration agreement. Blockchain and embodiments disclosed herein may provide support for data integrity of collected network performance and measurement data. After the performance and measurement data are written into the blockchain, it cannot be modified and may be audited at any time. This may enable the participating operators to identify if the collected performance data has been tampered with during the measurement data collection process. In various embodiments, the blockchain system may enable trust between different operators. For example, the hosting operator may sign smart contracts with the participating operators, in which a detailed SLA may be defined, enforced, and the corresponding payments may be automatically executed according to the SLA.

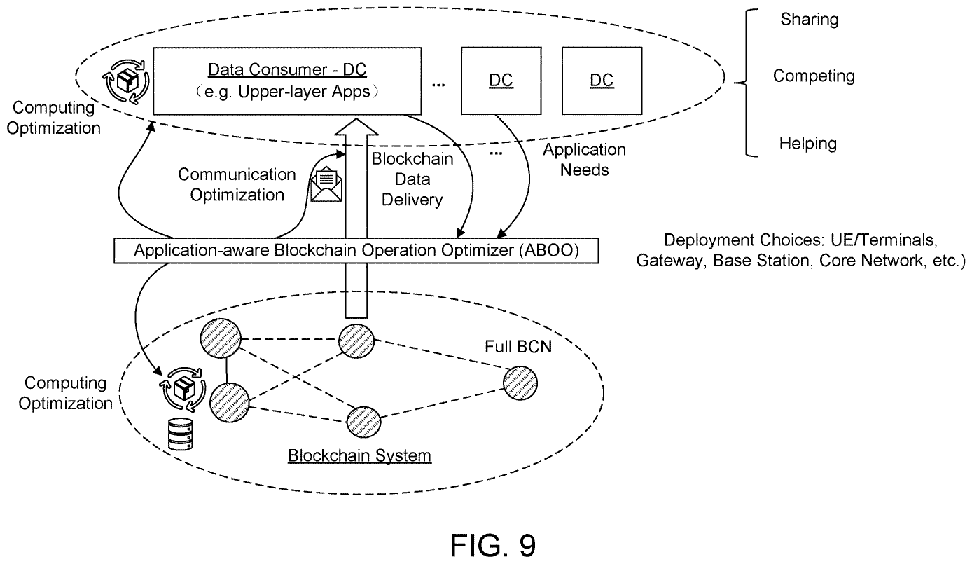

Although blockchain technology has various advantages (e.g., supporting data exchange between untrusted entities, supporting immutability, supporting native incentivization, etc.), when blockchain is adopted to support an application (e.g., the data sharing scenarios as shown in the previous two use cases), it also brings certain overhead in terms of computing, communication/network costs. Embodiments disclosed herein may optimize the blockchain-involved operations, e.g., by reducing corresponding computing/communication overhead (e.g., to make blockchain solutions applicable to applications in 5G and 6G wireless systems). Embodiments disclosed herein may address one or more of the following issues and challenges (as shown in FIG. 8).

Issue 1: Lack of coordination between DCs who share the same blockchain data interests. DCs interact with blockchain system individually without any collaboration/coordination, which may lead to repetitive operation costs in terms of computing/communication overhead on the blockchain-related processing. Various social data may be shared between different participant UEs via blockchain. Conventionally, each UE interacts with the blockchain network and conducts all the blockchain-related operations individually. A result of which is that, it leads to certain computing and communication overhead due to repetitive operations and communications. For example, even though many UEs may have the same interests for a certain type of data (e.g., Type-1 data), they conduct individual/separate data retrieval operations to obtain the desired data from a Full BCN. Similarly, even if data retrieval overhead is not an issue (in case the volume is large, e.g., hashed data), each UE conducts separate/repetitive blockchain-related processing, such as blockchain data verification operation (which leads to computing overhead on UEs). In addition, it is possible that obtaining the desired data from blockchain may not be free. As a result, UEs pay separate fees for the data and there is no cost-sharing ability among UEs having the same/similar data interests. Since UEs do not know and/or trust each other (e.g., natively), it is hard to prompt sharing among UEs, which leads to the aforementioned overhead.

Issue 2: On the Full BCN side, the transaction filtering operation only takes into consideration “static” DC specified data types and does not consider various real-time dynamics/changes (such as limited network resources and conditions) and the potential competition/contentions among DCs for those limited resources. As shown in FIG. 8, the Full BCN side sorts out the relevant transactions from the blocks based on the filter configured by UE-1. After that, the required processing (Stages 2-4) are executed on the filtered transactions. The data interests described by the filter only reflect the static information and do not reflect real-time dynamics. For example, even though UE-1 indicated that it is interested in Type-1 data, but currently (around 9:40 am Jun. 29, 2022) UE-1 may not be available or already be overloaded with other important tasks, i.e., UE-1 currently might not want to obtain any data from the Full BCN. This may be akin to a scenario when Amy says she likes pizza it does not mean she wants to eat pizza now (because she is not hungry at this moment). Additionally, the real-time dynamics reflect on the current communication/network conditions. For example, the current network condition between DCs in a locale and the Full BCN in the cloud can only afford to transmit a limited number of transactions. Such a real-time dynamic (i.e., the network resource scarcity) may result in certain competitions or contentions among DCs (e.g., which transactions shall be delivered), which have not been well addressed.

Issue 3: Existing blockchain-related operations/processing do not support capability/capacity sharing and helping between different DCs. Currently DCs interact with blockchain network separately, which means that they cannot help and collaborate with each other. Different DCs may have different capabilities. For example, some of DCs may conduct blockchain-related processing (e.g., conducting blockchain data verification) while some of DCs (e.g., resource-constrained devices) might not have such capabilities (so it will be useful if other resource-powerful DCs can provide help). As another example, some of DCs have the capability to interact with offline storage systems (such as The InterPlanetary File System, or IPFS) while some of DCs may not have the capability to do so. Different DCs may have different computing or communication capacities at different times. For example, at time t1, DC-1 in locale may have a very good connection to a Full BCN in the cloud while DC-2 has a poor wireless connection since DC-2 may have already used up its data plan for this month. It may be useful if DC-2 can help DC-1 to obtain the data from the Full BCN. As another example, at time t2, DC-3 is overloaded with other computing-intensive tasks and cannot conduct blockchain data verification while another nearby DC-4 has sufficient computing capacity and is willing to help. Currently there is no existing mechanism that may enable DCs to help each other in terms of capability or capacity sharing for blockchain-related operations/processing.

An application-aware blockchain operation optimizer (ABOO) may be used, defined, configured and/or determined. The ABOO may address the three issues. The Application-aware Blockchain Operation Optimizer (ABOO) may have different deployment choices. For example, the ABOO may be hosted by an edge terminal (such as a UE or a vehicle), an edge gateways (e.g., a roadside unit), an edge server (e.g., co-located at a base station), or a new NF in the 3GPP Core Network.

The ABOO's operation has three major phases, which consider three different types of relationships among DCs from an application-layer perspective: sharing, competing and helping.

The ABOO may be used, defined, configured and/or determined.

The Application-aware Blockchain Operation Optimizer (ABOO) may have different deployment choices. The ABOO aims to optimize blockchain-related operations so that the involved computing and communication resource cost/overhead may be reduced. In order to do that, the ABOO needs to collect or understand the business needs or requirements of the applications-layer entities, such as DCs. Based on those needs/requirements, the ABOO may coordinate DCs for optimizing blockchain-related operations.

The ABOO has three major phases, which consider three different types of relationships among DCs from an application-layer perspective, i.e., sharing, competing, and helping.

### Phase 1. Collective Data Interest Plan (CDIP) Creation and DC Blockchain Capability (DCBC) Registration

Phase 1 is mainly to consider the “interest sharing” relationship between DCs and the motivation is that if DCs share similar blockchain data interests, repetitive Blockchain-related operations may be avoided. During Phase 1, DCs sharing overlapping blockchain data interests may form a DC group and a CDIP may be created for this DC group. CDIP (to be deployed on a Full BCN for blockchain transactions filtering), eliminates repetitive blockchain operations/processing since DCs do not have to interact with the blockchain system separately.

Two approaches are proposed for Phase 1: 1) ABOO-initiated CDIP Creation and DCBC Registration; and 2) Full BCN-initiated CDIP Creation and DCBC Registration.

### Phase 2. Determination of Blockchain Data Delivery Priority List with Real-Time Dynamics

Phase 2 is mainly to consider the “competing/contention” relationship between DCs (in the same DC group). A Full BCN uses the CDIP (created in Phase 1) to filter relevant transactions. However, the communication and computing resources are often limited at any specific time due to real-time dynamics, which means not all of the filtered transactions may be delivered/processed. The goal of Phase 2 is that given a set of filtered transactions to be delivered to a group of DCs by a Full BCN, a data/transaction delivery priority (the output of Phase 2) shall be decided so that the limited communication/computing resources may be utilized in the best way (due to the resource scarcity, deciding such a list involves resolving competition or contention among DCs).

Two approaches are proposed for Phase 2: 1) ABOO-dominant Procedure of Deciding Delivery Priority List; and 2) Full BCN-dominant Procedure of Deciding Delivery Priority List.

### Phase 3. Cooperative Blockchain Data Delivery and Processing

Phase 3 is mainly to consider the “helping” relationship between DCs and aims to address Issue 3. Phase 3's task is that given a data delivery priority list (output by Phase 2) of a set of filtered transactions, how to come up with a concrete delivery solution (e.g., to select which helpers and leverage which DCBCs of those helpers in order to retrieve the desired data/transactions from blockchain system, conduct required blockchain processing if needed, and finally delivered the processed/verified final data/transactions to the beneficiaries of the data).

In an example, Phase 3 involves two operations: 1) a procedure of TSU Delivery Solution (TDS) Determination; and 2) a procedure of TDS Execution Collaborated Among Helpers.

In an example, the above is a “comprehensive” version of ABOO, which combines all ideas together, i.e., ABOO considers all three relationships (sharing, contention, helping). However, it is worth noting that, the ideas proposed in different phases may also be regarded as standalone solutions. In other words, they may be applied individually, and are applicable to different types of application scenarios.

### Representative Architecture of an Application-Aware Blockchain Operation Optimizer (ABOO)

Data Provider (DP): DP is the provider of data to be recorded in the blockchain system for sharing. The data could be any application-specific data recorded in the blockchain (such as transaction records for ad hoc payment, data exchange/sharing records, any application data, the hash of the application data if the data is stored in offline storage, etc.). A DP could be installed on various entities (such as mobile terminals, UEs, roadside units, gateways, routers, TVs, machines, IoT devices, customer premise equipment, RAN/CN nodes, edge & cloud apps, etc.).

Data Consumers (DC): DC is an entity that needs to use/consume the data. The DC could be any application software installed on various entities (such as mobile terminals, UEs, roadside units, gateways, routers, TVs, machines, IoT devices, customer premise equipment, edge & cloud apps, etc.). The DCs could also be various entities or network functions in a 3GPP wireless system, such as base stations, network functions in the core network, etc. In this case, the data could refer to different types of wireless-related data, such as UE channel status, network performances and measurements, network events, etc.

Blockchain System: Blockchain may be used as an efficient distributed sharing medium and provide various advantages compared to centralized shared storage (e.g., cloud storage), such as anti-tampering, traceability, high visibility, etc. One or more embodiments discussed herein consider using a blockchain system in a way such that the data from DPs could be stored in the blockchain for DCs to access. Typically, a blockchain system consists of numerous Blockchain Nodes (BCNs).

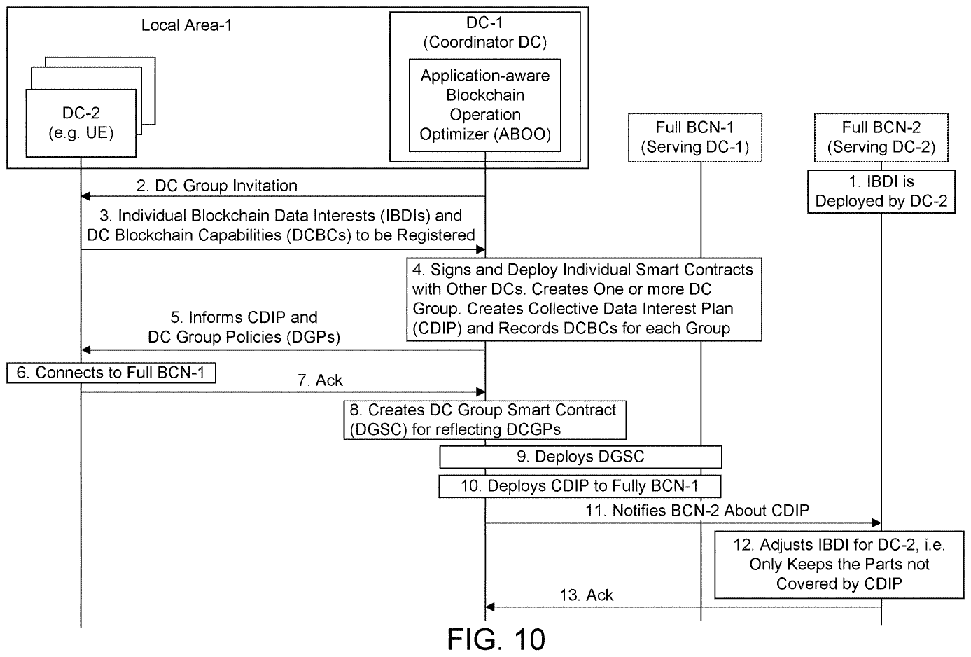

FIG. 9 is a block diagram illustrating an example architecture of an application-aware blockchain operation optimizer (ABOO). The ABOO may be used, defined, configured and/or determined.

The Application-aware Blockchain Operation Optimizer (ABOO) may have different deployment choices. The ABOO aims to optimize blockchain-related operations so that the involved computing and communication resource cost/overhead may be reduced. In order to do that, the ABOO needs to collect or understand the business needs or requirements of the applications-layer entities, such as DCs. Based on those needs/requirements, the ABOO may coordinate DCs for optimizing blockchain-related operations.

The ABOO has three major phases, which consider three different types of relationships among DCs from an application-layer perspective, i.e., sharing, competing, and helping.

### Phase 1. Collective Data Interest Plan (CDIP) Creation and DC Blockchain Capability (DCBC) Registration.

Phase 1 considers the “interest sharing” relationship between DCs and aims to address Issue 1. The motivation is that if DCs have similar blockchain data interests, repetitive Blockchain-related operations may be avoided, which will be beneficial for reducing communication and computing overhead. For example, only one DC needs to retrieve data from the blockchain system and other DCs may save the effort to interact with or obtain the same data from the Full BCNs (e.g., deployed in the cloud). Another example, only one DC needs to conduct blockchain-related operation/processing if a certain trust relationship may be established among DCs (e.g., DC-1 may trust DC-2's assertion about whether a set of blockchain transactions are recorded in the blockchain system via DC-2's blockchain data verification operation). In addition, if accessing data from blockchain system is not free, the involved fees may also be split among DCs having the same interests. Accordingly, during Phase 1, DCs sharing the overlapped blockchain data interests may form a DC group and a CDIP may be created for this group. By deploying the CDIP onto Full BCNs, it is expected to eliminate the repetitive blockchain operations/processing since DCs do not have to interact with the blockchain system separately and the required blockchain processing needs to be executed once for the members in the DC group. In order to enable collaborative blockchain processing/accessing, another objective of Phase 1 is for DCs to register their various blockchain capabilities (defined as DCBC) to ABOO. In other words, DCs may help each other. For a given piece of blockchain data (e.g., Data-1), DCs who are the real consumers of Data-1 are defined as the beneficiaries of Data-1. However, other DCs (as helpers) may provide various help on the required blockchain-related operations/processing during the delivery process of Data-1 to the corresponding beneficiaries. For example, a DC-1 (as a helper) is willing to contribute and register its blockchain capabilities (e.g., able to have a high-bandwidth connection to a Full BCN, able to conduct computing-intensive blockchain processing, e.g., Merkle proof, able to interact with an offline storage system e.g., IPFS, etc.) to ABOO. By registering DCBCs, ABOO (in Phase 3) may assign certain tasks to the desired helpers to help other DCs (as beneficiaries). The outcome of Phase 1 is a CDIP. CDIP represents common blockchain data interests of multiple DCs forming as a DC group and CDIP is to be deployed on Full BCNs for blockchain transactions filtering.

### Phase 2. Determination of Blockchain Data Delivery Priority List with Real-Time Dynamics

Phase 2 considers the “competing/contention” relationship between DCs (in the same DC group) and aims to address Issue 2. A Full BCN uses the CDIP (created in Phase 1) of a DC group to filter related transactions and prepare to deliver them to the DCs in the group. However, the communication and computing resources are often limited in reality, and only partial transactions may be delivered from the Full BCNs to DCs. Also, the real-time needs/interests of DCs are another factor to be considered (e.g., some of DCs may be busy with more important tasks and may not have the capacity to digest/consume any new transactions). The goal of Phase 2 is that given a set of filtered transactions to be delivered to a group of DCs by a Full BCN, a data/transaction delivery priority list shall be decided so that the limited communication/computing resources may be utilized in the best way. For example, due to resource scarcity, deciding on such a list involves competition or contention among DCs since high-priority transactions may be successfully delivered using the limited communication/computing resources while the low-priority transactions may not get delivered because of resource exhaustion.

### Phase 3. Cooperative Blockchain Data Delivery and Processing

Phase 3 considers the “helping” relationship between DCs and aims to address Issue 3. The motivation is that the data delivery priority list determined in Phase 2 only indicates which data (i.e., “who”) shall be delivered to who (and with what priority) but does not specify “how” the data shall be delivered or processed. In Phase 3, ABOO determines a concrete delivery solution for a given set of transactions. ABOO may leverage the DCBC information of DCs and assign tasks to the desired DCs (as helpers). For example, a DC (as a beneficiary) may pay a certain fee to ask other DCs (as helpers) to help to deliver a set of transactions. The term “delivery” may refer to a series of actions, including retrieving/receiving transactions from a full BCN, conducting the needed blockchain processing, and further retrieving final data from offline blockchain storage (in case the hashed data stored in the blockchain system is the offline storing address of the final data), etc.

One or more of the following may be applicable to all embodiments disclosed herein.

In various embodiments, blockchain technology is used as a generic term to represent much broader distributed ledger technology; in other words, blockchain technology and distributed ledger technology are used synonymously or interchangeably in this invention. As such, one or more embodiments discussed herein are also applicable to any specific blockchain technology and/or distributed ledger technology.

Various embodiments take the 3GPP 5G system as a typical example of a wireless system. However, one or more embodiments discussed herein may also be used to collect wireless data from the future generation of the 3GPP system (e.g., 5G beyond systems and/or a 6G system), as well as any other types of wireless systems.

When explaining the details of the proposed solutions, this invention uses cellphones, UEs, base stations, and network functions as an example of entities in the wireless system. However, it is worth noting that the proposed solutions in this invention may also be applied to any terminals or entities, such as but not limited to laptops, Internet-of-Things devices, equipment, future cellphones, drones, roadside units, laptops, TV set-top boxes, gateways, access points, satellites, sensor nodes, robots, machines, routers, base stations, radio access network central units, radio access network distribution units, radio access network radio units, network functions in 5GS and/or 6GS, etc.

As discussed early, two cases exist regarding how a Light BCN wants to obtain blockchain data from a Full BCN:

Case 1: New Transaction Case. When a Full BCN receives new blocks that are to be appended to the blockchain, it needs to use the filter to sort out relevant transactions to be delivered to a Light BCN (i.e., a DC).

Case 2: Historical Transaction Case. When a Light BCN, as a DC, connects to the blockchain network for the first time (or has been offline for a long time), the Light BCN first needs to sync up with the Full BCN by retrieving the historical transactions relevant to it (stored in the existing blocks).

Although we mainly use Case 1 for illustrating the proposed ideas, it is worth noting that the proposed ideas may also be applied to Case 2 as well.

One or more embodiments discussed herein discuss some specific blockchain operations, such as blockchain data verification, or even more specifically, the Merkle Tree (which is a specific approach for blockchain data verification). However, the proposed solutions are not only limited to transaction verification or Merkle Tree. In fact, the proposed solutions are to optimize any blockchain-related processing and communication, as long as they may incur certain computing/communication overhead that needs to be optimized (by the proposed ABOO).

### Representative Phase 1. Collective Data Interest Plan (CDIP) Creation and DC Blockchain Capability (DCBC) Registration

### Representative ABOO-Initiated Approach

In Phase 1, multiple proximal and untrusted DCs (e.g., those residing in the same local area) may have similar needs to access data from the blockchain system. At least one (or more) DC becomes a Coordinator DC if it installs an ABOO. A Coordinator DC may advertise its ABOO service and corresponding service level, service prices, contact address, etc. using various approaches (e.g., a local cellular broadcast, D2D-based advertisement dissemination, or coordinator DC may write its ABOO advertisement in the blockchain system for other DCs to discover). Other DCs may choose a desired Coordinator DC based on the service level/prices for using ABOO and sign a smart contract with the Coordinator DC in order to establish the trust. For easy presentation, it is assumed that there is one Coordinator DC in a local area and other DCs have already discovered the ABOO service as advocated by Coordinator DC. The ABOO solicits the respective data needs/interests from different nearby DCs. The objective is that DCs sharing common blockchain data interests may form a DC group (another smart contract may be created for the DC group), instead of conducting individual/separate blockchain data access and processing by themselves via the ABOO. In case a service fee is needed for obtaining desired data from the blockchain system, the smart contract may define how the cost/fee shall be split among multiple DCs in the same group. In the meantime, during Phase 1, DCs may also register their respective DC Blockchain Capabilities (DCBCs) to ABOO so that they may contribute their capabilities and help other DCs during Phase 3.

Based on the individual data interests solicited from different DCs, a Collective Data Interests Plan(s) (CDIP) may be generated by ABOO via interest integration, which will be sent to a Full BCN and used by the Full BCN for transaction filtering. In particular, since the CDIP merges the common data interests of multiple DCs, it may help in the potential computing and communication cost saving for the related blockchain data processing and delivery. For example, the Full BCN will not deliver the same piece of data to multiple DCs. Instead, the Full BCN may use CDIP for filtering out common-interested data/transactions and deliver one copy of the common-interested data/transactions to some (e.g., one) of the DCs in the group (this may save potential communication costs). Also, on the DC side, only one DC needs to conduct the required blockchain processing, e.g., blockchain data verification (e.g., Merkle Proof) in order to make sure the received data/transactions from the Full BCN are recorded in the blockchain system). After that, based on the trusted relationship established among DCs, the verified data/transactions may be further shared with other DCs in the DC group (e.g., the helpers may deliver the verified data to beneficiaries via D2D communication), who do not need to conduct the same processing anymore (this may save potential computing costs for those DCs).

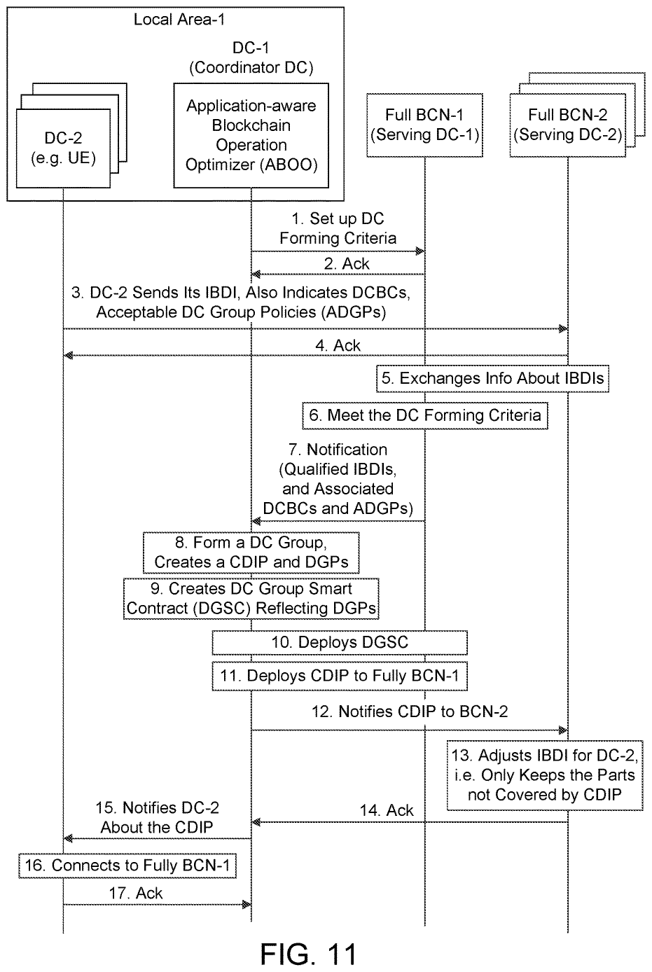

FIG. 10 illustrates an example procedure 1000 for enabling and/or carrying out CDIP creation and/or DCBC registration. The procedure 1000 is described with reference to the communications system 100 (FIG. 1) for convenience and simplicity of exposition. The procedure 1000 may be carried out using different architectures as well. The procedure 1000 may be suitable (used) for scenarios in which an ABOO may initiate CDIP creation and/or DCBC registration.

The term “step” as set forth in the disclosures accompanying FIGS. 10-15, 18 and 21 (along with the rest of the disclosures) is understood to encompass “one or more operations” and the terms “step and “operation(s)” may be used interchangeably herein.

Pre-conditions: A plurality of DCs (e.g., mobile terminals, such as UEs) may be present in (e.g., reside in, be situated in, etc.) a locale or like-type area or region (collectively “locale”). The locale may be, e.g., a park or other locality, a bus or other vehicle, a geographically defined area, an area corresponding to coverage of one or more cells (e.g., one, two or a few cells), an area delineated based on reception of wireless signals from one or more base stations (e.g., one, two or a few base stations), etc.

The DCs may have connectivity with, be connected to and/or be served by a plurality of (e.g., respective plurality of) Full BCNs (“serving full BCNs”). The DCs may have connectivity with, be connected to and/or be served by, the serving full BCNs, for example, to receive one or more blockchain data/transactions. For example, each of DCs may have connectivity with, be connected to and/or be served by, one of the serving full BCNs, for example, to receive the blockchain data/transactions relevant to data interests of the DC (e.g., the blockchain data/transactions determined pertinent to the DC in connection with (e.g., after, upon, when, based on, responsive to, on condition of, etc.) satisfying one or more of various criteria, a rubric, etc.).

Each of the DCs may retain connectivity with, remain connected to and/or continue to be served by, one or more of the serving Full BCNs to receive blockchain data/transactions and may connect to, establish connectivity with, and/or be served by one or more other Full BCNs, e.g., to query or talk with such other Full BCNs (which may also be referred to as serving Full BCNs). For example, as shown in FIG. 10, the DCs may include a first DC (“DC-1”) and a second DC (“DC-2”), and the DC-1 and the DC-2 may have connectivity with, be connected to and/or be served by, a first serving Full BCN (“Full BCN-1”) and a second serving Full BCN (“Full BCN-2”) respectively. Alternatively, two or more of the DCs may have connectivity with, be connected to and/or be served by, the same serving Full BCN (not shown).

The disclosures accompanying FIG. 10 that follow assume (i) the DC-1 and the DC-2 may have connectivity with, be connected to and/or be served by, the Full BCN-1 and the Full BCN-2, respectively; and (ii) the DC-1 may be equipped with an ABOO and may function as a Coordinator DC.

Step 1. The DC-2 may provide a first rubric (“blockchain-data rubric”) for certain blockchain data relevant to data interests of the DC 2 to the serving Full BCN-2. For example, the DC-2 may deploy the first blockchain-data rubric to the serving Full BCN-2 (e.g., via one or more transmissions between the DC-2 and the serving Full BCN-2). The first blockchain-data rubric may include one or more rules, guidelines, protocols, information, conditions, criteria, parameters, and/or the like associated with the certain blockchain data. The rules, guidelines, protocols, information, conditions, criteria, parameters, and/or the like may include, for example, information indicating one or more types of data and/or one or more rules specifying or indicating that any blockchain transaction having a first type of data (Type-1 data) and/or a second type of data (Type-2 data) is to be (or may be) delivered to the DC-2. In some embodiments, the first blockchain-data rubric may include the information indicating one or more types of data, and the Full BCN-2 may be (pre)configured with the rules specifying or indicating that any blockchain transaction having the Type-1 data and/or the Type-2 data is to be (or may be) delivered to the DC-2. In some embodiments, the first blockchain-data rubric may include the information indicating one or more types of data and information indicating one or more rules specifying or indicating that any blockchain transaction having he Type-1 data and/or the Type-2 data is to be (or may be) delivered to the DC-2, and the Full BCN-2 may be (pre)configured with the rules. The first blockchain-data rubric may include other rules, guidelines, protocols, information, conditions, criteria, parameters, and/or the like disclosed herein supra and infra.

The serving Full BCN-2 may use the first blockchain-data rubric to determine (e.g., select) the blockchain data relevant to the data interests of the DC-2 for delivery to the DC-2, and may deliver the determined blockchain data to the DC-2. For example, the serving Full BCN-2 may use the first blockchain-data rubric to filter certain blockchain transactions from other blockchain transactions (e.g., a larger set of blockchain transactions), and may deliver (e.g., only deliver) to the DC-the certain transactions relevant to the data interests of the DC-2. In various embodiments, the first blockchain-data rubric may be used for filtering any new block and/or for filtering historical blocks, e.g., in connection with the DC-2 synchronizing with the historical blocks after connecting to the blockchain network (e.g., in connection with connecting to the blockchain network for the purpose of synchronizing with the historical blocks or for the purpose of synchronizing with the historical blocks first).

Although not shown, one or more of the other DCs may provide/deploy blockchain-data rubrics to corresponding serving Full BCNs, and the serving Full BCNs may use such blockchain-data rubrics accordingly. The terms “blockchain-data rubric”, the terms “individual blockchain data interests” and/or its acronym “IBDI,” may be used interchangeably herein. The blockchain data that is the subject a blockchain-data rubric, the terms “data interests”, the terms “data interests”, the terms “interested blockchain data”, the terms “relevant blockchain data”, the terms “blockchain transaction of interest”, the terms “interested blockchain transaction”, the terms “relevant blockchain transaction” and the like may be used interchangeably herein.

Step 2. A DC, such as DC-1, may send to one or more of the other DCs (e.g., via unicast, broadcast and/or multicast communications) information indicating an invitation and/or interest solicitation to become (join as) a member of a group of DCs that may use an ABOO of such DC. For example, the DC-1 may decide to, and/or may, contact other DCs (e.g., nearby DCs) and provide thereto the information indicating an invitation and/or interest solicitation to (i) join together as a group of DCs (e.g., become initial members forming a group of DCs) that may use the ABOO of the DC-1 and/or (ii) join (e.g., become members of) an existing group of DCs that may use the ABOO of the DC-1 (collectively “DC group invitation”). The DC-1 may provide the DC group invitation in various forms. For example, the DC-1 may advertise its ABOO service for optimizing the blockchain-related operations/processing and one or more corresponding service levels, one or more service prices, one or more contact addresses, etc. The DC-1 may advertise the ABOO service and the corresponding service levels, service prices, contact addresses, etc. using various approaches. For example, the DC-1 may advertise the ABOO service using any of (i) a broadcast (e.g., a local cellular broadcast), (ii) a D2D-based advertisement dissemination (e.g., the ABOO may be an edge application hosted by a UE), and (iii) as coordinator DC, the DC-1 may write (e.g., submit a transaction having) an advertisement advertising the ABOO service and the corresponding service levels, service prices, contact addresses, etc. in the blockchain system for other DCs to discover.

The DC group invitation may include one or more of various information, conditions, criteria, parameters, and/or the like. The various information, conditions, criteria, parameters, and/or the like may include any of (i) an identifier of the coordinator DC; (ii) an identifier of the ABOO; (iii) information indicating, and/or criteria and/or parameters of, a service/served area; (iv) information indicating, and/or criteria and/or parameters of, one or more blockchain systems; (v) one or more indications of information solicited from one or more of the DCs; and (vi) a proposed smart contract.

The information indicating, and/or criteria and/or parameters of, a service/served area may indicate a serving area of the ABOO. For example, the DC-1 may indicate that the ABOO may serve DCs within the locale (which as detailed supra may be a park or other locality, a bus or other vehicle,, a geographically defined area, an area corresponding to coverage of one or more cells (e.g., one, two or a few cells), an area delineated based on reception of wireless signals from one or more base stations (e.g., one, two or a few base stations). Other examples of the local may include a bus terminal, a customer premises network (CPN), a personal IoT network (PIN), an NPN, etc.). Any of the DCs that may be present in (e.g., reside in, be situated in, etc.) the locale may utilize the ABOO.

The information indicating, and/or criteria and/or parameters of, one or more blockchain systems may indicate which types of blockchain systems the ABOO may provide help in optimizing blockchain-related operations. For example, the ABOO may indicate that a supported blockchain system is Ethereum. The DCs that interact with Ethereum may be served by the ABOO. The ABOO may provide help for different types of blockchain systems.

The information to be solicited from one or more of the DCs may include, e.g., respective IBDIs (current IBDIs). For example, the DC-2 may have deployed the first IBDI on the serving Full BCN-2, and the solicited from the DC-2 may be the first IBDI or a second, deployable IBDI. The first and second IBDIs may be mutually exclusive or be different with at least some overlapping criteria.

The one or more indications of information solicited from one or more of the DCs may be and/or include, e.g., information indicating various blockchain-related capabilities, e.g., blockchain-related capabilities that may contribute to helping other DCs, i.e., DCBCs. Examples of the blockchain-related capabilities may include (i) a capability of having a high-bandwidth connection to a Full BCN, (ii) a capability for conducting required blockchain processing, e.g., blockchain data verification or any other computing-related processing, (iii) a capability for interacting with a particular offline storage system e.g., IPFS, (iv) etc.

The proposed smart contract may include, e.g., information indicating proposed terms for a smart contract for the ABOO service (e.g., for use, and/or for participating in performance, of the ABOO service). The proposed smart contract may be executed between the Coordinator DC (e.g., the DC-1) and each of the other DCs (e.g., DC-2) that may become (join as) a member of a group of DCs that may use, and/or participate in performance of, the ABOO service.

Step 3. The DC-2 may decide to join the DC group and use the ABOO for receiving relevant data/transactions from the blockchain system. The DC-2 may send a second blockchain-data rubric/IBDI to the ABOO. If the second IBDI is updated after being sent to the ABOO, the DC-2 may inform the ABOO of the updated second IBDI (or only the updates to the second IBDI), e.g., in accordance with or similar to Step 3. The ABOO may make adjustments based on the updates to the second IDBI (e.g., to put the DC-2 in a different DC group, etc.). In various embodiments, the second IBDI may include rich information about the data interests of the DC-2. The second blockchain-data rubric/IBDI, like the first blockchain-data rubric/IBDI, may include one or more of various rules, guidelines, protocols, information, conditions, criteria, parameters, etc. The various rules, guidelines, protocols, information, conditions, criteria, parameters, etc. of the second IBDI may include, for example, any of (i) an identifier associated with the second IBDI; (ii) information indicating a serving Full BCN; (iii) information indicating a location of a DC; and (iv) information indicating one or more types of data. The terms “information indicating one or more types of data”, the terms “data interests” and the terms “information indicating one or more types of data/data interests” may be used interchangeably herein.

The identifier associated with the second IBDI may be any of an identifier of the second IBDI and an identifier of a DC providing the second IDBI, e.g., an identifier of the DC-2.

The information indicating a serving Full BCN may indicate which Full BCN is a serving BCN of the DC-2, e.g., the Full BCN-2. This information may imply that the first IBDI of the DC-2 may have been and/or may be deployed to/at the Full BCN-2.

The information indicating a location of a DC may indicate a location of the DC-2 (e.g., a current or expected location of the DC-2). The information indicating a location of a DC may be expressed, e.g., in terms of geocoordinates and/or civic locations.

The information indicating one or more types of data may indicate various types of blockchain data/transactions having data that can be delivered to the DC-2 (e.g., matching and/or according the data interests of the DC-2. For example, the information indicating the types of data may indicate Type-1 data and/or Type-2 data may be delivered to the DC-2. The Type-1 data and/or the Type-2 data may be delivered to the DC-2, for example, based on the one or more data-interest criteria and/or rules specifying or indicating that any blockchain transaction having the Type-1 data and/or the Type-2 data is to be (or may be) delivered to the DC-2. The rules may include a default rule, and the default rule may specify or indicate that any blockchain transaction having data matching or corresponding to the indicated types of data/data interests is to be (or may be) delivered to the DC-2. The rules may include another rule that may specify or indicate that any blockchain transaction having data matching or corresponding to the indicated types of data/data interests is to be (or may be) delivered to the DC-2 based on an event, condition being satisfied, etc. The second IBDI may include one or more the rules, or one or more of the rules may be (pre)configured to the DC-2.

The second IBDI may be different from the first IBDI For example, the types of data/data-interests indicated in (by) the second IBDI sent to the ABOO may be different from the types of data in the first IBDI provided to/deployed in the Full BCN-2. For example, the information indicating the types of data/data interests in the first IBDI provided to/deployed in the Full BCN-2 may indicate one or more types of sensitive data (“Type-X data”), such as, e.g., personally identifiable information (PII), sensitive PII, etc., whereas the information indicating the types of data/data interests in the second IBDI sent to the ABOO might not indicate the Type-X data (e.g., due to privacy concerns, restrictions, etc.) and/or one or more of the other types of data/data interests indicated in the first IBDI, if any (and vice versa). In various embodiments, the types of data/data interests indicated in the first IBDI may be mutually exclusive of the types of data indicated in the second IBDI. In various embodiments, the types of data/data interests in the second IBDI may be the same as the types of data/data interests in the first IBDI. In various embodiments, at least one of the types of data/data interests in the second IBDI is the same as at least one of the types of data/data interests in the first IBDI.

In various embodiments, the DC-2 may be provided relevant blockchain data from the Full-BCN and the ABOO based at least in part on the types of data indicated in the first IBDI and the types of data indicated in the second IBDI, e.g., as disclosed supra. For example, the DC-2 may be provided Type-X data from the Full-BCN and data other than the Type-X data from the ABOO.

One or more of various rules, guidelines, protocols, information, conditions, criteria, parameters, etc. may be specified (e.g., in second blockchain-data rubric/IBDI) for some or all of the types of data/data interests indicated in the second blockchain-data rubric/IBDI. The various rules, guidelines, protocols, information, conditions, criteria, parameters, etc. for at least one (or each) of the types of data/data interests indicated in the second blockchain-data rubric/IBDI may include one or more requirements and/or parameters for how the DC-2 intends to receive the relevant data. In various embodiments, the various rules, guidelines, protocols, information, conditions, criteria, parameters, etc. for at least one (or each) of the types of data/data interests indicated in the second blockchain-data rubric/IBDI may include (i) one or more lifetime parameters, (ii) one or more data quality metrics, (iii) information indicating a data provider, (iv) information indicating offline storage; and (v) information indicating blockchain-related operations.

Each of the lifetime parameters may indicate a time period or a set of time periods during which the DC-2 is operable to (or expects to) receive a type of data indicated in the second blockchain-data rubric/IBDI. Following an expiration of a lifetime parameter, the DC-2 might not be operable to (or expect to) receive the corresponding type of data indicated in the second blockchain-data rubric/IBDI.

The data quality metrics may indicate one or more quality metrics for some or all of the types of data/data interests indicated in the second blockchain-data rubric/IBDI. Blockchain transactions having data satisfying at least one of the quality metrics may be delivered to the DC-2. For example, the data quality metrics may indicate a minimum quality level of high quality for Type-1 data, blockchain transactions having Type-1 data satisfying the minimum quality level of high quality may be delivered to the DC-2. In various embodiments, blockchain transactions having Type-1 data failing to satisfy the minimum quality level of high quality might not, need not, or are not delivered to the DC-2. In various embodiments, blockchain transactions having Type-1 data failing to satisfy the minimum quality level of high quality may be delivered to the DC-2 based on alternative metrics/rules (e.g., no Type-1 data that satisfies the minimum quality level of high quality is provided/received in a period of time).

The information indicating a data provider may indicate one or more data provider for some or all of the types of data/data interests indicated in the second blockchain-data rubric/IBDI. For example, such information may indicate a list (or collection) of one or more DPs for a type of data indicated in the second blockchain-data rubric/IBDI, and blockchain transactions created by the DPs on the list (or that are members of the collection) may be delivered to DC-2. In various embodiments, blockchain transactions created by the DPs not on the list (or that are not members of the collection) might not, need not be or are not delivered to the DC-2. In various embodiments, blockchain transactions that created by the DPs not on the list (or that are not members of the collection) may be delivered to the DC-2 based on alternative metrics/rules (e.g., no blockchain transactions created by the indicated DPs a provided/received in a period of time).

The information indicating offline storage may indicate a list (or collection) of one or more offline storage systems. For example, in embodiments in which data recorded in the blockchain system is hashed data and an address of full data stored in an offline storage system, the DC-2 may interact with the offline storage system to retrieve the full data. The information indicating offline storage may indicate a list (or collection) of one or more preferred offline storage system. The list may be ordered by precedence (e.g., increasing or decreasing precedence). Among the reasons for including this information in the second blockchain-data rubric/IBDI may be that the DC-2 might not trust certain offline storage systems, the DC-2 may lack capabilities to interact with certain offline storage system, certain offline storage systems do not meet fiscal policies (e.g., are not free or too expensive to use), etc.

The information indicating blockchain-related operations may indicate one or more blockchain-related operations to be carried out by another DC on behalf of the DC-2. For example, the DC-2 might not have (or may lack) a capability for obtaining data directly from a Full BCNs and/or might not have (or may lack) a capability for conducting one or more operations/processing. The information indicating blockchain-related operations may indicate blockchain-related operations corresponding to capabilities that the DC-2 may lack. Such blockchain-related operations may be (e.g., expected to be) supported by helpers. As an example, to deliver a set of blockchain transactions containing Type-1 data from the Full BCN-2 to the DC-2, the following operations/processing may be carried out, where the DC-2 may be the beneficiary and the data delivery process may be helped by one or more helpers.

Operation 1: The relevant transactions having Type-1 data may be sent to a first helper in the locale. The relevant transactions having Type-1 data may be sent to a first helper because, for example, the DC-2 currently has a very poor connection with the serving Full BCN-2 for receiving the transactions. Those transactions may be transmitted to the first helper, which could be one of the DCs in a of the DC-2.

Operation 2: After the relevant data/transactions are received by the first helper, the relevant data/transactions may undergo blockchain processing, e.g., blockchain data verification to ensure recordation in the blockchain system. The first helper, like the DC-2, may lack that capability. A second helper in the locale (e.g., within a vicinity of the first helper) possesses the capability to perform the blockchain processing. The first helper may transmit the relevant data/transactions to the second helper. The second helper may use the capability to perform the blockchain processing and conduct the computing-intensive verification.

Operation 3: The verified transactions may include address information of an offline storage system. The second helper may lack capabilities to extract the address information from the verified transactions and retrieve the full data from the offline storage system. A third helper in the locale (e.g., within a vicinity of the second helper) possesses such capabilities. The third helper may extract the address information from the verified transactions and may retrieve the full data from the offline storage system. The third helper may deliver the full data to the DC-2 (e.g., completing the delivery process). After delivery, the DC-2 may consume it.

Although three different helpers may carry out the operations/processing 1-3 on behalf of the DC-2 (as the beneficiary) according to the preceding example, more or fewer than three helpers may carry out the operations/processing 1-3 on behalf of the DC-2 (as the beneficiary). Alternatively, the DC-2 (as the beneficiary) may only carry out zero or more blockchain-related operations, and may rely on one or more helpers to carry out other blockchain-related operations.

The term “operation” as set forth in the disclosures above is understood to encompass “one or more operations” and the identification of an operation using a reference numeral is for simplicity of exposition.

The DC-2 may determine to contribute its DCBCs to help other DCs. The DC-2 may register its DCBCs to the ABOO. The DC-2 may indicate its various blockchain-related capabilities for some or all of various types of data (e.g., Type-3 data). Various blockchain-related capability information may be sent from the DC-2 to the ABOO in connection with registering the DCBCs to the ABOO. The various blockchain-related capability information may include any of (i) information indicating supported types of data, (ii) information indicating blockchain processing/operations, and (iii) API and URL-related information.

The information indicating supported types of data may indicate one or more types of data (e.g., Type-3 data) applicable to/supported by the blockchain-related capabilities.

The information indicating blockchain processing/operations may indicate, for some or all of the supported types of data corresponding blockchain processing/operations available from and/or provided by the DC-2 as a helper. The blockchain processing/operations available from and/or provided by the DC-2 for a supported type of data may include and/or be based on, for example, one or more capabilities for interacting with Full BCNs of one or more blockchain systems, one or more capabilities to carry out blockchain operations/processing, one or more capabilities for interacting with offline storage systems, etc.

Each of the capabilities for interacting with Full BCNs of one or more blockchain systems may be specific to a type of blockchain system. For example, the capabilities for interacting with Full BCNs of one or more blockchain systems may include a capability to interact with a Full BCN of Ethereum. By way of example, the DC-2 may have a good connection to a Full BCN in Ethereum and Full BCN in Ethereum may use the good connection to deliver blockchain data to a locale where the DC-2 is or was last present.

The capabilities to carry out blockchain operations/processing may include a capability to carry out a specific blockchain operation/processing, e.g., for each of one or more specific blockchain operation/processing. For example, the capabilities to carry out blockchain operations/processing may include a capability of the DC-2 to carry out blockchain data verification operation.

The capabilities for interacting with offline storage systems may include a capability to interact a specific offline storage systems, e.g., for each of one or more offline storage systems. As an example, the capabilities for interacting with offline storage systems may include a capability to interact with an IPFS, etc.

The ABOO may use the API and URL-related information to assign tasks to the DC-2.

The DC-2 may send to the ABOO hosted by the Coordinator DC (the DC-1) information indicating an agreement to the proposed smart contract proposal sent from the ABOO.

Step 4. The DC-1 may receive a response from the other DCs (e.g., DC-2). If it is a positive response, it means those DCs (e.g., DC-2) would like to use the ABOO service provided by DC-1. Accordingly, DC-1 may need to complete the following actions:

For any DCs (e.g., DC-2) that would like to use the ABOO service provided by DC-1, it will sign an individual smart contract with each of those DCs (based on the agreed smart contract proposal), which specifies how ABOO shall provide service to those DCs. Accordingly, those signed smart contracts will be deployed to the blockchain system so that those DCs may establish trust with the Coordinator DC, i.e., DC-1.

For the received IBDIs, the ABOO will need to analyze and integrates multiple IBDIs from different DCs. In particular, by finding the common parts among IBDIs, one or more DC groups may be created. There could be various decision algorithms for deciding how to create a DC group. One of the examples could be that if a set of IBDIs are deployed on the same blockchain system and they share a sufficient amount of common data interests, the corresponding DCs of those IBDIs could potentially form a DC group.

Assuming that ABOO creates a DC group, the next step is to create a Collective Data Interest Plan (CDIP) for this group. In the meantime, ABOO also records DCBCs registered by the DCs in this group. The purpose of CDIP may be to combine all the data interests from multiple DCs and there are several cases to be handled:

Case 1. A given type of data that is interested by multiple DCs. For example, the IBDIs of multiple DCs indicate that they are interested in Type-1 data. In this case, this data type will be included in the CDIP. Note that, it is possible that different DCs may have the same interests in Type-1 data, but they may have subtle differences in the detailed requirements, such as desired data qualities, desired data providers, etc. In Phase 1, the ABOO aims to identify and maximize the common parts of data interests among different DCs. For example, it is possible that DC-3 needs high-quality Type-1 data but DC-4 does not care about the data quality. Then, ABOO will decide to only deliver high-quality Type-1 data since it may serve both DC-3 and DC-4. Similarly, if DC-5 only wants Type-1 data provided by data provider-1 and data provider-3 while DC-6 only wants Type-1 data provided by data provider-3 and data provider-4, then the ABOO will decide to only deliver data provided by data provider-3 since it may serve both DC-5 and DC-6. In addition, ABOO may further conduct more negotiations with different DCs when certain requirements are conflicted (e.g., one DC requires high-quality data while another DC requires low-quality data).

Case 2. During the interest integration, it is possible that one data type may only be interested by a single DC (e.g., DC-2). In this case, ABOO may still provide help during Phase 3. For example, it is possible that DC-2 (as a beneficiary) may not have the capabilities to conduct any required blockchain-related operations/processing, and therefore, DC-2 may still rely on ABOO to help in finding other helpers for conducting those required blockchain-related operations. Alternatively, it is also possible that the DC-1 hosting ABOO may also have various DCBCs and therefore DC-1 itself may also act as a potential helper to other DCs.

The CDIP may include one or more of the following information elements: (i) an identifier of the CDIP (“CDIP identifier”); (ii) a creator of the CDIP (“CDIP creator”); (iii) a time of creation of the CDIP (“CDIP creation time”); (iv) a group identifier of the DC group (“DC group ID”) corresponding to the CDIP (“corresponding DC group ID”); (v) a list of members of the DC group (“DC member list”); (vi) serving Full BCN(s) of the CDIP; (vii) associated data types; and (viii) delivery criteria for one or more (e.g., each) of the associated data types.

The CDIP creator may be, for example, an identifier of the ABOO and/or an identifier of the Coordinator DC (i.e., DC-1). The CDIP creation time may indicate when (e.g., at time at which) the CDIP is created. The corresponding DC group ID may be or indicate the DC group ID of the corresponding DC group. The involved DC member list may indicate the DCs to be served by the CDIP (those DCs are the beneficiaries of this CDIP). The list may also indicate the members of a DC group.

The serving Full BCN(s) of the CDIP may indicate one or more Full BCNs (e.g., Full BCN-1) on which the CDIP may be deployed. The serving Full BCN(s) of the CDIP may indicate more than one Full BCN in instances where the CDIP may be deployed to more than one Full BCN, e.g., for system redundancy purposes. For example, if one serving Full BCN goes offline, another Full BCN may take the job to conduct transaction filtering. In various embodiments, a Light BCN may receive filtered transactions from one Full BCN node since all the Full BCNs are supposed to have the same copy of the blockchain data.

The associated data types. may indicate the CDIP may be used for delivering one or more certain data types. For example, the CDIP may help to deliver Type-1 data interested by both DC-2 and DC-3.

For a given associated data type (Type-1 data), agreed requirements/needs regarding how the transaction including Type-1 data may be delivered to one or more involved DCs, may include one or more of: 1) the identifier of involved DCs in the DC group, who want to receive Type-1 data; 2) Agreed data quality requirement. For example, all the involved DCs would like to receive high-quality Type-1 data; 3) Agreed desired data provider. For example, all the involved DCs would like to receive Type-1 data provided by data provider-3445; and/or 4) Agreed desired offline storage list. For example, all the involved DCs would like to retrieve additional data from a specific offline storage system (e.g., IPFS).

Step 5. The ABOO informs the created CDIP to DC-2 and other DCs of the same DC group so that DC-2 will know how the ABOO will help it for obtaining desired data from the blockchain system. From the CDIP, DCs will know about who are in the same DC group since they need to collaborate with each other during Phase 3.

The ABOO also needs to define certain DC group policies (DGPS), which may specify the following information:

Rules/Policies regarding how to share the cost among DCs (as beneficiaries). For example, both DC-2 and DC-3 need Type-1 data but obtaining Type-1 data from a blockchain system may require a certain service fee or cost. One DGP rule could define that the incurred service fee or cost shall be split among all the beneficiaries.

Rules/Policies regarding how to split the earned service fee among DCs (as helpers). DCs acting as helpers use their DCBCs to provide blockchain-related operation support to DC beneficiaries. The rule may define that the service fee paid by multiple beneficiaries may be shared/allocated among multiple involved helpers.

Other security or privacy-related penalty rules.

For example, a DC-2 shall not disclose data interest information of other DCs (as described in CDIP) to other parties. For example, during Phase 3, in case DC-2 (as a helper) uses its DCBC capability to help another DC-3 (as beneficiary) to retrieve a piece of data (e.g., Type-1 data) from an offline storage and deliver to DC-3 (this means DC-2 may potentially know the interests of DC-3). However, such a help event will be recorded by the blockchain system. Accordingly, once in the future DC-3 finds its data interest on Type-1 data is leaked, it is easy to trace the help events recorded in the blockchain system and identify the suspicious one who leaked this information, i.e., DC-2 in this example. As a result, a certain penalty could be applied to DC-2.

A DC-2 (as helper) shall not leak the retrieved blockchain data to other unauthorized parties when DC-2 (as helper) users its DCBCs to help others (beneficiaries).

DC-2 shall be punished if it claims it has already completed the blockchain data verifications for Type-1 data (in order to earn the service fee), although indeed it has not ever executed such an operation.

Step 6. DC-2 reviews the CDIP and DGPs and agrees to the proposed CDIP and DGPs. In the meantime, since CDIP is to be deployed to the Full BCN-1, DC-2 may build another connection to Full BCN-1 (Note that, DC-2 may still keep the original connection with Full BCN-2 if it still wants Full BCN-2 to deliver the sensitive data). In case DC-1 may not fully agree with the DGPs, a certain negotiation process may be conducted. Otherwise, if DC-2 rejects, it will not be included in the DC group for this time.

Step 7. DC-2 sends an acknowledgment to ABOO for the notification about CDIP and DGPs.

Step 8. ABOO creates a DC Group Smart Contract (DGSC) for all the DCs in the DC group. In particular, the DGSC is created based on the DGPs so that those DGPs may be automatically enforced. For example, in the later Phase 3, once DC-1 (as a beneficiary) asks ABOO to help in delivering a piece of interested data, the promised service fee payment of DC-1 may be deposited in the smart contract. Accordingly, once the data is successfully delivered to DC-1 using the help of other DCs (as helpers), the service fee paid by DC-1 may be automatically allocated/split among those helpers. Also, the created CDIP and the registered DCBCs may also be recorded in the DGSC, along with associated DGPs (for example, a DC may get punished if it cheats for a certain DCBC). In addition, remember that each of DCs in the DC group has already established trust with the Coordinator DC (e.g., DC-1) when they would like to use the ABOO service provided by DC-1 during Step 4. Therefore, in this step, DCs in the group will trust the information as described in the DGSC as prepared by DC-1. Then, since the CDIP included in the DGSC indicates the DC member list of the DC group, which enables all the involved DCs to know each other, which further enables a collaboration trust among all the DCs in the group.

The trust among DCs may be built in two steps: 1) DCs sign individual smart contracts with ABOO so that trusts may be established between them; and 2) ABOO creates the DC group. Since ABOO informs DCs about the DC group information (including the DC member list) and a group smart contract (DGP) is created for the group, DCs in the same DC group may trust each other (i.e., ABOO acts as an intermediate trust anchor).

Step 9. The ABOO deploys the created DGSC to the blockchain system in order to make it take into effect.

Step 10. The ABOO also deploys CDIP to Fully BCN-1. Now, Full BCN-1 starts to use CDIP to filter any blocks (either the new blocks or the historical blocks as requested by DCs or during data synchronization).

Step 11. After CDIP deployment, it means that some common-interested data will be filtered out by CDIP. However, as indicated in Step 1, an IBDI has already been deployed by DC-2 to the Full BCN-2 before the creation of CDIP. As a result, the ABOO needs to notify the Full BCN-2 about the newly created CDIP.

Step 12. After receiving CDIP, the Full BCN-2 will temporally suspend the operation of IBDI deployed by DC-2. Then, the Full BCN-2 will adjust and update the IBDI so that the updated IBDI will only be responsible for filtering out the interested transactions that are not covered by the CDIP. For example, it is possible that the CDIP will be used by Full BCN-1 for filtering out Type-1 and Type-2 data for DC-2 (as well as other DCs sharing the common interest). However, due to privacy or any purpose, the updated IBDI will still be used by Fully BCN-2 for filtering out Type-6 and Type-7 data (and delivering to DC-2), which are not covered by the CDIP. If the updated IBDI becomes useless or void, DC-1 may choose to terminate the current connection to Full BCN-2 since it will get all the relevant transactions from Full BCN-1 (relying on CDIP).

Step 13. The Full BCN-2 sends an acknowledgment that the corresponding adjustment of IBDI of DC-2 has already been made or updated.

### Representative Full BCN-Initiated Approach

In an alternative approach, the ABOO will not directly contact DCs to solicit the respective data needs/interests. Instead, ABOO will set a DC group forming criteria and send it to a Full BCN (e.g., Full BCN-1). On the DC side, different DCs may deploy their respective IBDIs on their serving Full BCNs and also record their DCBCs in the blockchain system. During the operation, the Full BCN-1 may periodically exchange information about IBDIs with other Full BCNs. By analyzing those IBDIs, the Full BCN-1 may decide whether the DC group forming criteria are met and whether a potential DC group shall be created. If so, the Full BCN-1 will send the necessary information to ABOO (e.g., the involved IBDIs, DCBCs) so that the ABOO may proceed with CDIP creation and DCBC registrations.

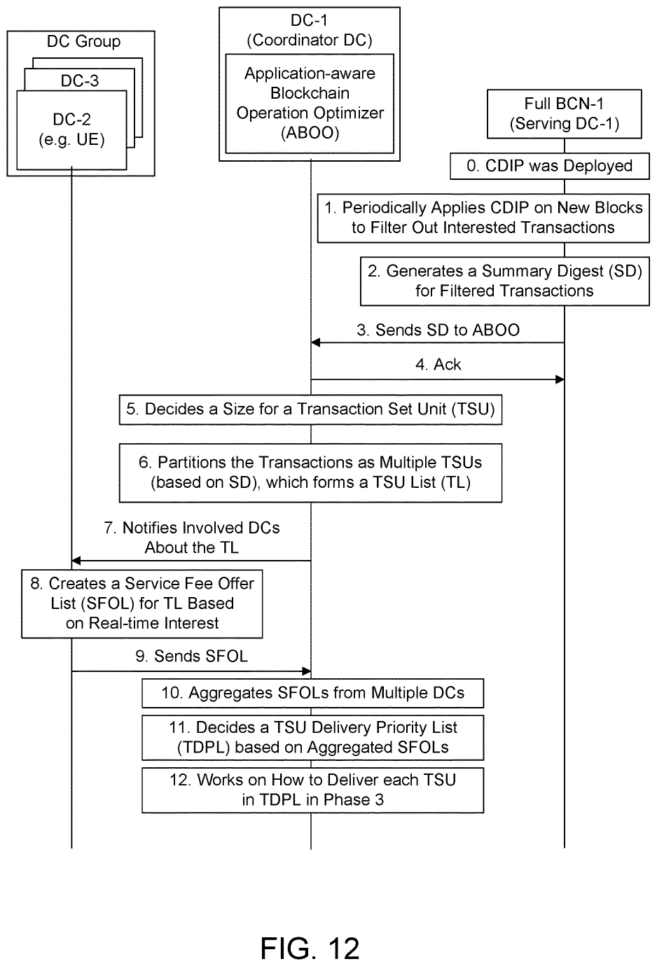

FIG. 11 illustrates an example procedure 1100 for enabling and/or carrying out CDIP creation and/or DCBC registration. The procedure 1100 is described with reference to the communications system 100 (FIG. 1) for convenience and simplicity of exposition. The procedure 1100 may be carried out using different architectures as well. The procedure 1100 may be suitable (used) for scenarios in which a Full BCN may initiate CDIP creation and/or DCBC registration.

Precondition: Multiple DCs (e.g., mobile terminals, such as UEs) reside in a Local Aerea-1, such as DC-1 and DC-2. Each DC is connected to a Serving Full BCN in order to interact with the blockchain system. For example, Full BCN-1 and Full BCN-2 are the Serving BCN of DC-1 and DC-2 respectively.

Step 1. The ABOO (hosted by DC-1) sets up a DC forming criteria and sends it to the Full BCN-1. The detailed parameters of this step may include:

The minimum number of DCs that could form a DC group. Assuming this number is 5, it means that every time the Full BCN-1 needs to select at least five different DCs in order to decide whether a DC group shall be created for those DCs.

The minimum number of overlapped interested data type(s). Another criteria is that among the candidate DCs, a DC group may be created only if their IBDIs have sufficiently overlapped data interests. For example, given five IBDIs from 5 different DCs, a DC group may be created only if all of those five IBDIs have e.g., at least three interested data types in common (e.g., all of IBDIs are interested in Type-1 data, Type-2 data, Type-4 data).

Step 2. The Full BCN-1 sends an acknowledgment to ABOO that DC forming criteria is configured.

Note that Step 1 and Step 2 may happen after Step 3 and Step 4.

Step 3. DC-2 sends its IBDI to its serving Full BCN, i.e., Full BCN-2 so that the Full BCN-2 will use the IBDI to filter out the blockchain transactions for DC-2 and only deliver relevant transactions to DC-2. In the meantime, DC-2 also intends to record its DCBCs in the blockchain system. As a result, the parameters and information to be sent in this step are as the same as the information used in Step 3 of FIG. 10. In addition to that, DC-2 may also declare its Acceptable DC Group Policies (ADGPs) and record them in the blockchain system. Basically, the ADGPs indicate that if DC-2 is added to a DC group, which DGPs are acceptable to DC-2.

Step 4. The Full BCN-2 sends an acknowledgment to DC-2 indicating its IBDI has been deployed and its DCBCs and ADGPs have already been recorded in the blockchain.

Step 5. The Full BCN-1 periodically exchanges information with other Full BCNs. For example, the Full BCN-1 may exchange information with Full BCN-2 about what new IBDIs have been deployed on Full BCN-2 in the last two hours.

Step 6. The Full BCN-1 collects the knowledge about IBDIs (e.g., two IBDIs have been deployed on Full BCN-2 and four IBDIs have been deployed on Full BCN-3, etc.). Accordingly, the Full BCN-1 may examine different sets/combinations of IBDIs and analyze whether a particular set of IBDIs meets the DC forming criteria.

Step 7. Once the DC forming criteria is met, it will trigger Full BCN-1 to send a notification to ABOO. In particular, the Full BCN-1 will send the following information to ABOO, which shall be used by ABOO for CDIP creation and DCBC registration operation: 1) a list of involved IBDIs; and/or 2) for each involved IBDIs: a) the identifier of the IBDI, b) the identifier of the corresponding DC (e.g., DC-2), c) the identifiers of transactions containing the information about the DCBCs of the corresponding DC (e.g., DC-2), and/or d) the identifiers of transactions containing the ADGPs of the corresponding DC (e.g., DC-2).

Step 8. ABOO forms a DC group by integrating multiple IBDIs (based on the information in Step 7) and creates a CDIP (as same as Step 4 in FIG. 10). In the meantime, ABOO also registers the DCBCs of the involved DCs. ABOO also create a set of DC Group Policies (DGPs), which needs to be compliant with the ADGPs of the involved DCs (In this way, the ABOO does not need to further contact each DC for asking them to consent to the DGPs).

Step 9. ABOO creates DC Group Smart Contract (DGSC) reflecting DGPs. This step corresponds, and/or is akin, to Step 8 of FIG. 10.

Step 10. This step corresponds, and/or is akin, to Step 9 of FIG. 10.

Step 11. This step corresponds, and/or is akin, to Step 10 of FIG. 10.

Step 12. This step corresponds, and/or is akin, to Step 11 of FIG. 10.

Step 13. This step corresponds, and/or is akin, to Step 12 of FIG. 10.

Step 14. This step corresponds, and/or is akin, to Step 13 of FIG. 10.

Step 15. The ABOO notifies DC-2 about the CDIP and also indicates that a new CDIP is deployed on the Full BCN-1.

Step 16. DC-2 may make a connection to Fully BCN-1 if it intends to receive blockchain transactions directly from Full BCN-1. For example, when establishing the connection, the DC-2 may indicate its ID as well as associated CDIP to the ABOO. In addition, it is worth noting that DC-2 may still keep the original connection with Full BCN-2 if it still wants Full BCN-2 to deliver the sensitive data.

Step 17. DC-2 sends an acknowledgment to ABOO.

### Representative Phase 2. Determination of Blockchain Data Delivery Priority List with Real-Time Dynamics

CDIP is deployed on a Full BCN-1 (via Phase 1) to filter out transactions that are interested by multiple DCs in a DC group. However, in reality, given a set of filtered transactions, it may not be feasible or necessary to deliver all the filtered transactions to the DC group. This may be due to various reasons, e.g., some DCs may be currently busy with other more important tasks and cannot digest new transactions. Another reason could be that the networking condition between the Full BCN-1 and DC group (e.g., in Local Area-1) is not good such that only a limited number of transactions may be sent from the Full BCN-1. Therefore, certain “competing/contention” relationships (due to communication resource scarcity) between DCs should be considered when deciding which transactions shall be selected for transmission by the Full BCN, and Phase 2 aims to address the corresponding Issue 2.

In particular, the input of Phase 2 is a set of filtered transactions (by applying CDIP). During Phase 2, the system needs to decide on a data/transaction delivery priority list. Note that, such a delivery priority list only indicates “what” transactions shall have a high priority to be delivered from the Full BCN-1 but it does not define “how” those transactions are actually being delivered to the corresponding beneficiaries, which will be the focus and job of Phase 3. In other words, Phase 3 will start to process the delivery priority list (the output of Phase 2) from the beginning (which has higher priority) to the end. For each part in this list (i.e., a specific portion/set of transactions, which is defined as a Transaction Set Unit (TSU) in Phase 2), Phase 3 will come up with a real delivery solution using the currently-available communication and computing resources contributed by multiple helpers (based on their DCBCs registered to the ABOO during Phase 1).

### Representative ABOO-Dominant Approach

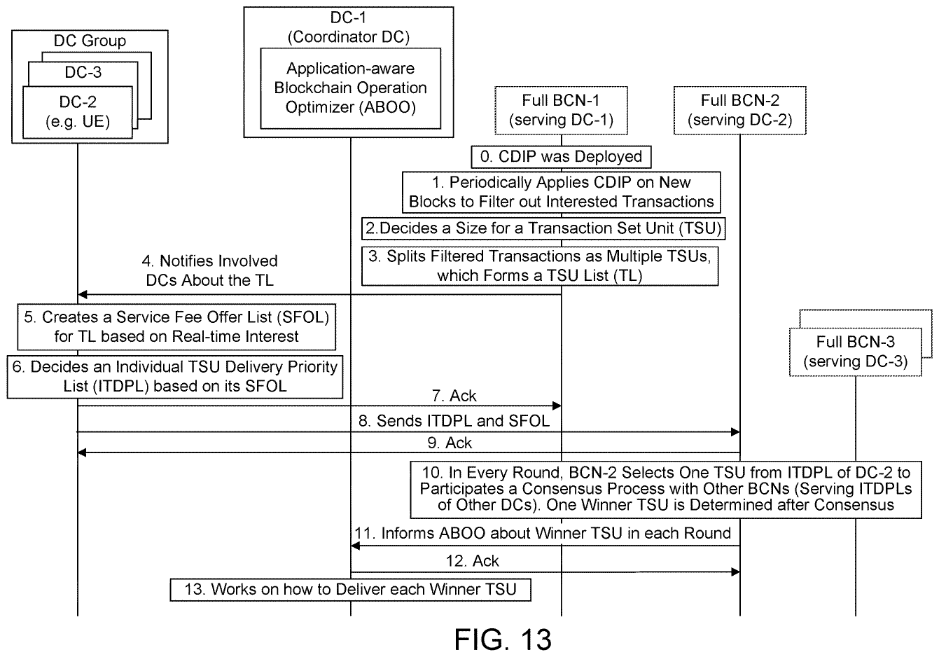

FIG. 12 illustrates an example procedure 1200 for determining delivery priority according to an ABOO-dominant approach. The procedure 1200 is described with reference to the communications system 100 (FIG. 1) for convenience and simplicity of exposition. The procedure 1200 may be carried out using different architectures as well. The procedure 1200 may be suitable (used) for scenarios in which a delivery priority list is determined according to an ABOO-dominant approach. In the ABOO-dominant approach, the delivery priority list is determined by an ABOO.

Step 0. During Phase-1, ABOO hosted on DC-1 (Coordinator DC) has already created a DC group and created a CDIP, that was deployed to Full BCN-1, which is the serving Full BCN of DC-1.

Step 1. Full BCN-1 periodically applies CDIP on newly created blocks to filter out relevant blockchain transactions interested by DCs in the DC group. Another case, for data synchronization purpose (as required by DCs e.g., when they connect to the blockchain system), Full BCN-1 filters out a new batch of transactions from the existing historical blocks.

Step 2. The Full BCN-1 generates a Summary Digest (SD) for the newly filtered transactions (Note that, how and when to create a new SD could be a system configured parameter. For example, a SD could be periodically created, e.g., every 5 mins. Or a new SD may be created based on size, e.g., if Full BCN-1 accumulates 10 MB new transactions, it could create a new SD. The SD will be sent to ABOO and the purpose of the SD is to describe what kinds of transactions are currently available at Full BCN-1 and need a delivery. Given a set of filtered transactions, the SD may have the following parameters:
The ID of SD.
The creation time of this SD.
The creator of this SD. For example, Full BCN-1 is the creator of this SD.
The associated CDIP of this SD. For example, the CDIP deployed by DC-1 (during Phase 1) is the associated CDIP of this SD.
The total size of the transaction set. For example, for the current batch, there are 10 MB of new transactions in total that were filtered out based on CDIP.
The data types involved in the transaction set. This is to indicate the data contained in the filtered transactions may be categorized to which data types. For example, the data contained in the 10 MB filtered transactions may involve Type-1 data, Type-2 data, Type-3 data.
For each involved data type, what is the corresponding data size. For example, among 10 MB filtered transactions, 3 MB transactions contain Type-1 data, 4 MB transactions contain Type-2 data and 3 MB transactions contain Type-3 data.

Step 3. Full BCN-1 sends the SD to ABOO in order to inform it about the newly filtered transactions.

Step 4. ABOO sends an acknowledgment about the new SD.

Step 5. The ABOO decides the size of a Transaction Set Unit (TSU). A TSU is a basic processing unit for ABOO to work out a delivery solution during Phase 3.

In particular, it is defined that transactions contained in the same TSU shall meet the following requirements:
Transactions in a TSU contain the same type of data. With this requirement, the whole TSU may be treated as a whole and ABOO could decide a TSU delivery solution for a TSU in Phase 3.
TSU size could be a system configured parameter. For example, it may be configured that a TSU may have a size ranging from 0-3 MB.

Step 6. Based on SD, The ABOO partitions the described transactions in the SD into multiple TSUs, which forms a TSU List (TL). For example, given a total 10 MB filtered transactions (where 3 MB transactions contain Type-1 data, 4 MB transactions contain Type-2 data, and 3 MB transactions contain Type-3 data), the 10 MB data will be partitioned and the following TSUs will be formed:
TSU-1: 3 MB Type-1 data.
TSU-2: 2 MB Type-2 data (e.g., for the first half of the 4 MB Type-2 data).
TSU-3: 2 MB Type-2 data (e.g., for the second half of the 4 MB Type-2 data).
TSU-4: 3 MB Type-3 data.

As a result, the TL will include TSU-1, TSU-2, TSU-3, and TSU-4.

Step 7. ABOO analyzes the corresponding CDIP and decides on a list of involved DCs, who are interested in the transactions contained in any TSU in the TL.

Step 8. Each involved DC (e.g., DC-2) receives the TL. Each DC creates a Service Fee Offer List (SFOL) for the TSUs in the TL based on their real-time interest. As an example, for DC-2, it may have the following cases:
DC-2 has indicated it is interested in Type-1 data, and now DC-2 still wants to receive the new transactions containing the Type-1 data. Therefore, DC-2 would like to pay $2 in maximal for TSU-1. In particular, the contention or competing relationship among DCs is reflected by how much service fee a DC would like to pay for a given TSU.
DC-2 has indicated it is interested in Type-2 data, but now DC-2 is kind of busy and it just wants to receive at most 2 MB of the new transactions containing the Type-2 data. In the meantime, compared to Type-1 data, Type-2 data is not that important. Therefore, DC-2 only wants to pay $1 in maximal for TSU-2, but does not want to pay any for TSU-3 since DC-2 does not want it now.
DC-2 has never indicated that it is interested in Type-3 data, and therefore, DC-2 does not want to pay any fee for TSU-4.

As a result, the SFOL of DC-2 will be like $2, $1, $0, $0 (which are corresponding to TSU-1, TSU-2, TSU-3, and TSU-4 respectively).

Step 9. The DCs (e.g., DC-2) send their respective SFOLs to ABOO. Each DC may indicate to ABOO how long its SFOL being applicable.

Step 10. ABOO aggregates SFOLs from multiple DCs. For example, the SFOL of DC-2 is like $2, $1, $0, $0, the SFOL of DC-3 is like $3, $0, $2, $3. The aggregated SFOL will be:
$2+$3=$5 (for TSU-1), $1+$0=$1 (for TSU-2), $0+$2=$2 (for TSU-3), $0+$3=$3 (for TSU-4)

Step 11. The ABOO decides on a TSU Delivery Priority List (TDPL) based on the aggregated SFOLs. For example, the ABOO will sort the above aggregated SFOL (based on the aggregated SFO values, i.e., the more service fee the DCs are willing to pay for a given TSU, the higher the delivery priority of this TSU will be) and then decides a TDPL as follows:
$5 (for TSU-1), $3 (for TSU-4), $2 (for TSU-3), $1+$0=$1 (for TSU-2)—in which TSU-1 has the highest delivery priority, while TSU-2 has the lowest delivery priority

Step 12. The above TDPL will be used by ABOO during Phase 3. For example, ABOO will start to work on how to deliver transactions as described by each TSU in TDPL based on their priority.

### Representative Full BCN-Dominant Approach

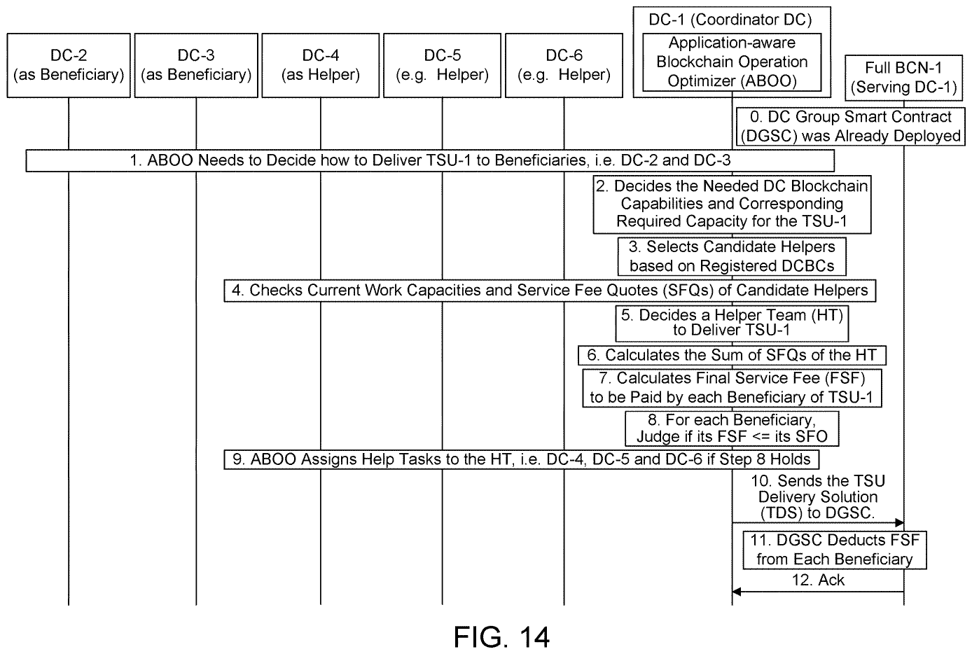

FIG. 13 illustrates an example procedure 1300 for determining delivery priority according to a Full-BCN-dominant approach. The procedure 1300 is described with reference to the communications system 100 (FIG. 1) for convenience and simplicity of exposition. The procedure 1300 may be carried out using different architectures as well. The procedure 1300 may be suitable (used) for scenarios in which a delivery priority list is determined according to a Full BCN-dominant approach. In the Full BCN-dominant approach, the delivery priority list is determined by the Full BCNs. The DCs and the ABOO might not or do not decide the TDPL. The consensus protocol of Full BCNs may be borrowed by DCs for deciding TDPL.

Step 0. Same as Step 0 of FIG. 12.

Step 1. Same as Step 1 of FIG. 12.

Step 2. Same as Step 5 of FIG. 12. But this time, the work is done by Full BCN-1.

Step 3. Same as Step 6 of FIG. 12. But this time, the work is done by Full BCN-1.

Step 4. Same as Step 7 of FIG. 12. But this time, the work is done by Full BCN-1.

Step 5. Same as Step 8 of FIG. 12. Using the same example used in FIG. 12, it is assumed that for DC-2, its SFOL will be like $2, $1, $0, $0 (which are corresponding to TSU-1, TSU-2, TSU-3, TSU-4 respectively).

Step 6. DC-2 decides an Individual TSU Delivery Priority List (ITDPL) based on its SFOL decided in Step 5. For example, TSUs will be ordered in ITDPL based on their corresponding SFOs. For example, the ITDPL of DC-2 will be TSU-1, TSU-2, TSU-3, TSU-4, where TSU-1 has the highest delivery priority (for DC-2) because its corresponding SFO has the highest value (i.e., $2).

Step 7. DC-2 sends an acknowledgment to Full BCN-1.

Step 8. The Serving Full BCN of DC-2 is Full BCN-2. Therefore, DC-2 intends to designate Full BCN-2 to participate in a consensus process (on behalf of DC-2) for determining a TDPL. Accordingly, DC-2 may send its ITDPL and the corresponding SFOL to Full BCN-2.

Step 9. The Full BCN-2 confirms the reception of ITDPL and SFOL sent from DC-2.

Step 10. After receiving ITDPL from all involved DCs, multiple Full BCNs (on behalf of different DCs respectively) will conduct a consensus process using a particular consensus protocol (such as PoW). In particular, the whole consensus process may include multiple rounds. In each round, the output will be a Winner TSU, which has a lower delivery priority than the Winner TSUs elected in the previous rounds, but has a higher delivery priority than the Winner TSUs to be agreed in the later rounds. As an example, it is assumed that 1) the ITDPL of DC-2 is like TSU-1, TSU-2, TSU-3, TSU-4, and Full BCN-2 participates in the consensus process for deciding TDPL on behalf of DC-2; 2) the ITDPL of DC-3 is like TSU-4, TSU-2, TSU-1, TSU-3, and Full BCN-3 participates the consensus process for deciding TDPL on behalf of DC-3.

In every round, every participant BCN will select one TSU having the highest priority as the candidate TSU from its ITDPL. For example, Full BCN-2 selects TSU-1 (from the ITDPL of DC-2) as the candidate TSU since it has the highest priority while Full BCN-3 selects TSU-4 as the candidate TSU since it has the highest priority in the ITDPL of DC-3. The consensus process will be executed among different Full BCNs. Taking PoW as an example, the mining difficulty parameter may be configured based on needs such that the speed of electing a Winner TSU for each consensus round may be adjusted. As a result, the candidate TSU of the Full BCN (who solves the PoW puzzle first) will be agreed upon as the Winner TSU for the current round.

Once a Winner TSU is elected in a round, each participating BCN will be informed, and the next round is started. Also, the Winner TSU will be immediately sent to ABOO so that ABOO may start to work on how to come up with a TSU delivery solution for the Winner TSU, which will be the details for Phase 3. In addition, assuming that TSU-1 is the Winner TSU after round-1, then in the round 2, the Full BCN-2 will select TSU-2 (from the ITDPL of DC-2) as the candidate TSU. However, for Full BCN-3, it will still select TSU-4 (from the ITDPL of DC-3) as the candidate TSU for round 2 since TSU-4 did not win during round-1. On the other hand, in the future rounds, Full BCN-3 also needs to skip TSU-1 in the ITDPL of DC-3 since TSU-1 has already been elected as the Winner TSU in round-1.

Step 11. Full BCN-2 (or any other Full BCN participating in the consensus process) informs ABOO about the Winner TSU in each round (e.g., TSU-1 for round-1). All the Winner TSUs will form a TDPL. In the meantime, for each Winner TSU, the Full BCN-2 also decides who are the beneficiaries of this TSU and collects the responding SFO of each beneficiary for the TSU-1, and the SFO information will also be sent to ABOO.

Step 12. ABOO sends an acknowledgment.

Step 13. The ABOO starts to work on how to deliver the Winner TSU for each round, which will be introduced in detail in Phase 3.

### Representative Phase 3. Cooperative Blockchain Data Delivery and Processing

The output of Phase 2 is a TDPL, in which the TSUs are ordered based on their delivery priorities (in descending order). For a given TSU in this TDPL, Phase 3 (focusing on “helping” between DCs and addressing Issue 3) is to decide on a real TSU Delivery Solution (TDS) for each TSU in the TDPL. There are two types of roles involved in Phase 3. The first role is the beneficiaries of this TSU, which basically are the DCs who will consume the data contained in this TSU. The second role is the helper, which is to contribute their DCBCs (registered to ABOO during Phase 1) and help in delivering the TSU to the corresponding beneficiaries. Since the communication/computing resources of helpers are also limited in reality, the earlier a TSU gets processed by ABOO, the more chance this TSU may finally get delivered successfully. In Phase 3, two procedures are involved, the first one is regarding how to decide a TDS for a given TSU and the second one is regarding given a decided TDS, how the involved helpers will work together to execute this TDS.

### Representative TSU Delivery Solution (TDS) Determination

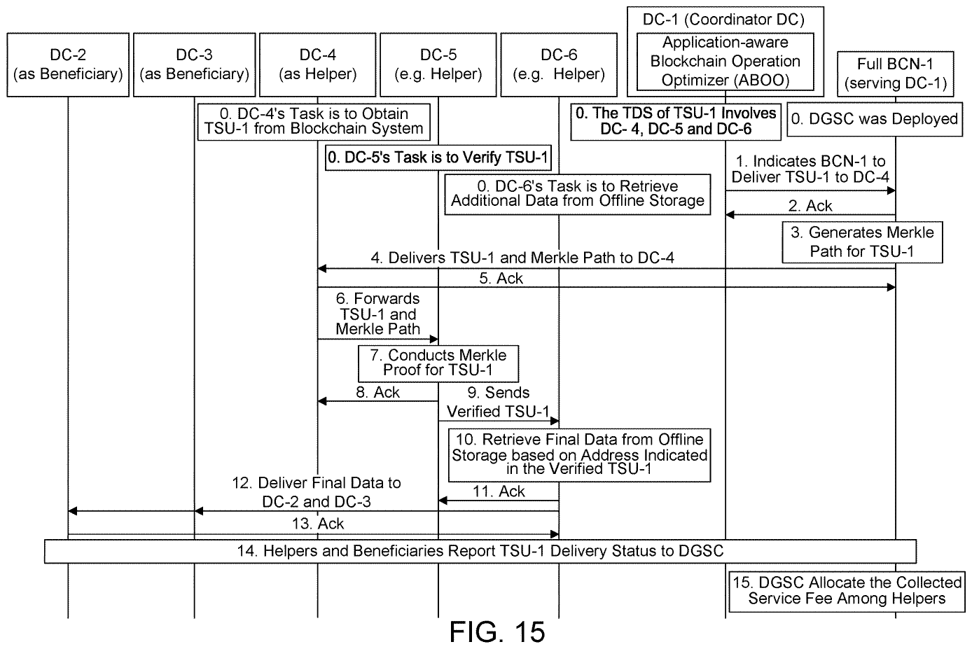

FIG. 14 illustrates an example procedure 1400 for TDS determination. The procedure 1400 is described with reference to the communications system 100 (FIG. 1) for convenience and simplicity of exposition. The procedure 1400 may be carried out using different architectures as well. The procedure 1400 may be suitable (used) for scenarios in which a TSU delivery solution (TDS) may be determined (for a given TSU).

Precondition. The smart contract DGSC was already deployed during Phase 1. A TSU-1 is outputted during Phase 2 (using either approach as proposed in Phase 2) and now it is the time for ABOO to come up with a TDS for TSU-1. A DC group includes a number of DCs (DC-1, DC-2, DC-3, DC-4, DC-5, DC-6), who are residing in the same local area, e.g., Local Area-1.

Step 1. ABOO needs to decide how to deliver TSU-1 to its beneficiaries, i.e., DC-2 and DC-3. In other words, in this example, DC-2 and DC-3 are the beneficiaries of transactions contained in TSU-1.

Step 2. In order to deliver TSU-1, ABOO needs help from potential helpers. For example, in order to deliver TSU-1, the following required processing/operations are needed (i.e., the TDS of TSU-1 will involve the following operations):

Operation 1: The TSU-1 first needs to be obtained/downloaded from a Full BCN, e.g., Full BCN-1 in this example. Therefore, one or more helpers currently having a good communication/networking connection are needed to obtain TSU-1. In this example, assuming that TSU-1 has the size of 3 MB, and therefore ABOO needs to check which potential helper(s) currently has good communication bandwidth to download TSU-1 from the Full BCN-1.

Operation 2: TSU-1 needs blockchain data processing, e.g., data verification in order to make sure transactions contained in TSU-1 are recorded in the blockchain system. Therefore, one or more helpers currently having sufficient computing capability/capacity is/are needed.

Operation 3: Assuming the transactions contained in TSU-1 include the hashed address of the additional data stored in an offline storage system, additional data needs to be retrieved based on the addresses after the blockchain data verification. Therefore, one or more helpers currently having the capability for interacting with a specific offline storage system is/are needed.

Step 3. The ABOO checks the DCBCs registered by different DCs during Phase 1 and selects candidate helpers. For example, DC-4, DC-5, DC-6 (also other DCs) are selected as the candidate helpers for delivering TSU-1. ABOO may also select DC-1 as the helper.

Step 4. The ABOO contacts each of the candidate helpers and checks their current work capacities and Service Fee Quotes (SFQs).

For example, for Operation 1: ABOO would like DC-4 to provide help (based on its registered DCBCs) since it is currently having a good connection to the Full BCN-1 and may obtain TSU-1 (having a size of 3 MB) from the Full BCN-1 in a few seconds. In the meantime, the ABOO also checks the SFQ of DC-4, which indicates how much DC-4 would like to charge for providing this communication-related help.

For Operation 2: ABOO would like DC-5 to provide help since it is currently having sufficient computing power and could verify transactions contained in TSU-1 in a few seconds. In the meantime, the ABOO also checks the SFQ of DC-5, which indicates how much the DC-5 would like to charge for providing this computing-related help.

For Operation 3: ABOO would like DC-6 to provide help since it has the needed capability to interact with a specific offline storage system. The ABOO also checks the SFQ of DC-6, which indicate how much the DC-6 would like to charge for providing this help.

Step 5. ABOO decides on a Helper Team (HT) to deliver TSU-1. For example, in this HT, DC-4, DC-5, DC-6 are included.

Step 6. ABOO calculates the sum of SFQs of the HT. In other words, this sum will be the total charge of the TDS of TSU-1. Such a total charge will be shared by the beneficiaries of TSU-1, i.e., DC-2 and DC-3.

Step 7. ABOO calculates Final Service Fee (FSF) to be paid by each beneficiary of TSU-1, i.e., DC-2 and DC-3. For example, a simple FSF calculation approach is to averagely split the sum of SFQs. In that case, it means each beneficiary needs to pay the same amount of service fee. Alternatively, a more sophisticated calculation approach may be used so that different beneficiaries do not have to pay the same amount of service fee (i.e., some may pay more while some may pay less).

Step 8. For each beneficiary (e.g., DC-2), remember that it has already indicated how much it would like to pay during Phase 2 (See Step 11 of FIG. 13), i.e., SFO (which indicates the maximum amount of service fee DC-2 would like to afford).

As a result, in this step, the ABOO needs to judge whether the FSF of DC-2 is no larger than the corresponding SFO. If so, it means that the service fee charged by the helpers of TSU-1 may be covered by the payments of DC-2 (same for other beneficiaries, e.g., DC-3).

Step 9. If Step 8 holds, which means each beneficiary would like to pay their shared service fee, and therefore it is time to assign the tasks for the helpers in the HT (i.e., DC-4, DC-5, DC-6), in order to trigger them for action. Otherwise, Steps 5-8 may be repeated until another feasible HT may be found. If not, it means that TSU-1 failed to be delivered at this time. It could be due to several reasons.

For example, it is impossible to find a set of desired helpers at this time since they do not have available computing or communication resources. This may happen especially when a TSU has a lower priority in the TDPL such that the computing/communication resources in the system have already been used up by other high-priority TSU delivery tasks. The service fee charged by helpers (i.e., the sum of SFQs) may be too high and beneficiaries cannot afford for paying the service fee.

Step 10. ABOO sends the decided TDS to Full BCN-1 in order to trigger DGSC smart contract. In a TDS, it includes the following parameters:
The ID of the TSU, i.e., TSU-1.
The IDs of involved beneficiaries, e.g., DC-2 and DC-3.
The FSFs to be paid by each of the beneficiaries.
The IDs of involved helpers, e.g., DC-4, DC-5, and DC-6.
The task assignment details, e.g.:
   DC-4 is responsible for obtaining the TSU-1 from the Full BCN-1. Also, certain performance requirements may be specified here.
   DC-5 is responsible for conducting blockchain data verification for TSU-1.
   DC-6 is responsible for retrieving additional data from a specific offline storage system, based on the verified data (e.g., address information) in TSU-1.

Step 11. DGSC receives the TDS of TSU-1, and it will record the details of the TDS and deducts the corresponding FSF from the account of each beneficiary (as a deposit).

Step 12. The Full BCN-1 sends an acknowledgment to ABOO.

### Representative Collaborative TDS Execution

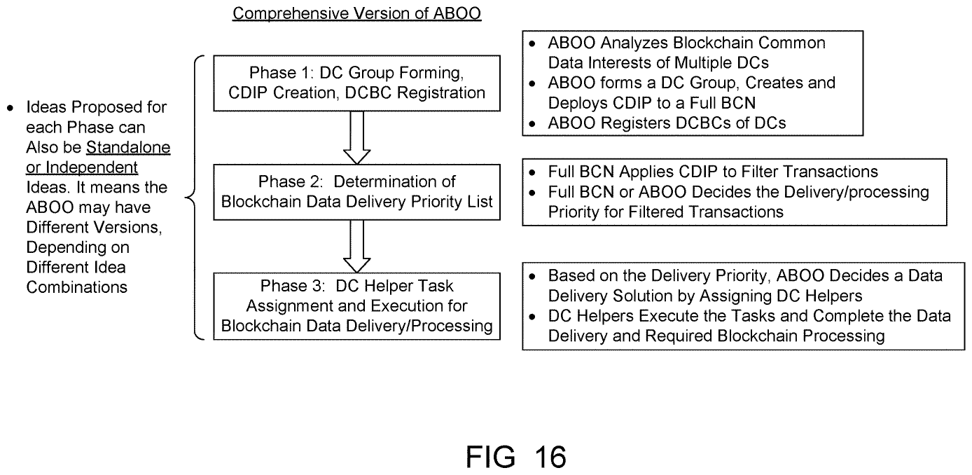

FIG. 15 illustrates an example procedure 1500 for collaborative TDS execution. The procedure 1500 is described with reference to the communications system 100 (FIG. 1) for convenience and simplicity of exposition. The procedure 1500 may be carried out using different architectures as well. The procedure 1500 may be suitable (used) for carrying out collaborative TDS execution, e.g., given a decided TDS.

Precondition. The smart contract DGSC is deployed and the beneficiaries of TSU-1 is DC-2 and DC-3. The TDS of TSU-1 determined by ABOO involves DC-4, DC-5, and DC-6 (as helpers). In this TDS, it indicates that DC-4's task is to obtain TSU-1 from the blockchain system (e.g., Full BCN-1). Then, DC-5's task is to verify TSU-1 (In this example, it assumes that Merkle Proof is used for blockchain data verification) and DC-6's task is to retrieve additional data from offline storage (which is the real data to be consumed by the beneficiaries).

Step 1. According to TSU, ABOO indicates BCN-1 to deliver TSU-1 to DC-4. For example, currently, DC-4 has an excellent connection to the Full BCN-1 and therefore, the Full BCN-1 will send TSU-1 to DC-4.

Step 2. Full BCN-1 sends an acknowledgment for the task assigned from ABOO.

Step 3. The Full BCN-1 generates Merkle Path for TSU-1, which will be needed when verifying TSU-1 by DC-5.

Step 4. The Full BCN-1 delivers TSU-1 and the corresponding Merkle Path to DC-4.

Step 5. DC-4 sends an acknowledgment to Full BCN-1 for successfully receiving TSU-1.

Step 6. DC-4 may choose a desired opportunity to forward TSU-1 to DC-5. For example, data exchange may use D2D communications between DC-4 and DC-5, or rely on an intermediate relay, such as a road-side unit.

Step 7. After obtaining TSU-1 from DC-4, DC-5 conducts the needed blockchain processing, e.g., blockchain data verification.

Step 8. DC-5 sends an acknowledgment to DC-4.

Step 9. DC-5 further sends the verified TSU-1 to DC-6.

Step 10. DC-6 extract the useful data from the verified blockchain transactions included in the TSU-1. For example, it is assumed that in this example, the valuable data are the address information, via which additional data may be retrieved from an offline storage system. As a result, DC-6 interacts with the offline storage system and retrieves additional data.

Step 11. DC-6 sends an acknowledgment to DC-5.

Step 12. DC-6 delivers the data (retrieved from the offline storage) to DC-2 and DC-3 respectively.

Step 13. DC-2 and DC-3 confirm their receptions of the final data. At this point, the whole delivery process for TSU-1 is complete.

Step 14. The helpers (DC-4, DC-5. DC-6) and beneficiaries (DC-2 and DC-3) report TSU-1 delivery status to DGSC. Also, they may rank their delivery performance and whether they are satisfied with the delivery, etc.

Step 15. Based on the DC group rules or policies, DGSC may decide the contributions of each helper and allocate the collected service fee among those helpers (The service fee has been collected from the beneficiaries during Step 11 of FIG. 14).

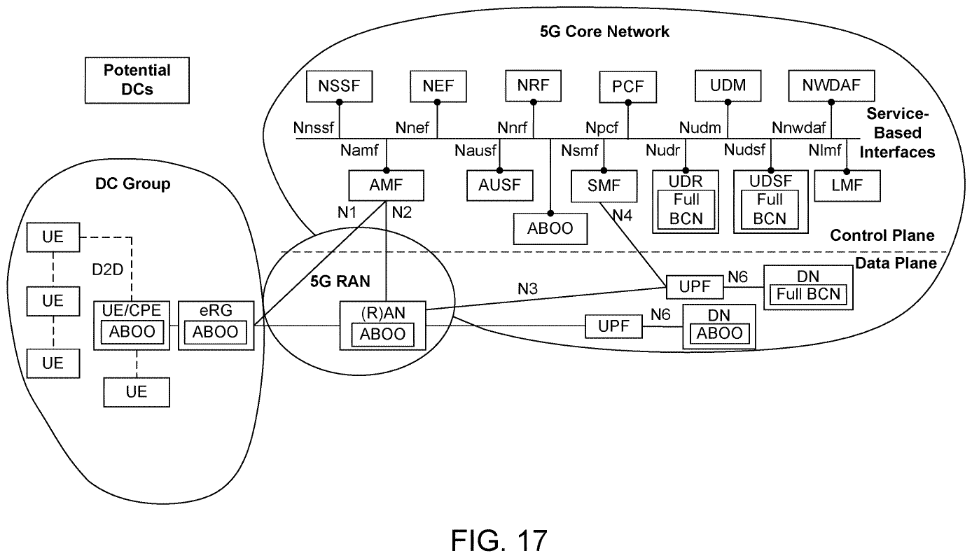

FIG. 16 illustrates an example of an ABOO, e.g., a version 0 of ABOO (e.g., a comprehensive version of ABOO) For a “comprehensive” version of ABOO (shown in FIG. 16), it addresses all of the three relationships, which has three phases. A task of Phase 1 is the analysis of common interests among DCs, leading to the creation of CDIP and the registrations of DCBCs of DCs. Then, in Phase 2, the Full BCN will apply the CDIP (created during Phase 1) to get filtered blockchain transactions, and the major focus of Phase 2 is to decide on a delivery priority list for those filtered blockchain transactions (e.g., which is applicable to the case where system computing/communication resources is limited and cannot afford for delivering/processing all of those transactions to DCs.). The decided delivered priority list will be the inputs of Phase 3, which decides a real delivery solution (e.g., assign appropriate helpers to help either on data delivery or on data processing) based on the priority list.

Version 0 may be considered a comprehensive solution of ABOO combining all ideas together. However, embodiments in different phases may be regarded as standalone solutions. In other words, they may be applied individually, and are applicable to different types of application scenarios. Below are how one or more embodiments discussed herein may be used individually or in a combined way.

### Representative Version 1 of ABOO

The ABOO only considers the “data interest sharing” aspect and the main task of the ABOO is to create CDIP.

Applicable Scenario: The DCs deploy their respective IBDIs. By collecting information of multiple IBDIs, the ABOO may form a DC group (in which the members share common data interests) and create a CDIP. In this case, the common data interest parts among different IBDIs are extracted and put into the CDIP (The original IBDIs also need to be updated, so that the common-interested data will not be individually delivered to each involved DC, so that the potential communication overhead may be saved). The CDIP will be deployed to a Full BCN for filtering the blockchain transactions. Once a set of desired transactions are filtered out by the Full BCN (using CDIP), those transactions will be delivered to the terminal/UE/node hosting ABOO. Then, ABOO is responsible for conducting further required processing on the blockchain transactions obtained from the Full BCN (so that each involved DC does not have to do processing individually, which saves the potential computing resources in the system). After that, DCs in the group could get the desired blockchain data from ABOO. Version 1 of the ABOO leverages CDIP.

### Representative Version 2 of ABOO

The ABOO only considers the “contention/competition” aspect and the main task of the ABOO is to decide a delivery priority list for a set of filtered transactions.

Applicable Scenario: The DCs deploy their respective IBDIs on a given Full BCN in the blockchain network. However, there may only be limited network communication/computing resources available in the system. Therefore, only a limited set of transactions shall be delivered to the targeted DCs. Then, the Full BCN needs to decide a delivery priority list. Based on such a delivery priority list, the Full BCN select which blockchain transactions shall be taken care of first. Since there is no CDIP and DC group concept being used in Version 2, it may have limited improvement regarding the potential communication/computing overhead optimization, and its main focus may be on delay-aware delivery optimization. For example, Version 2 considers the different importance/urgency of the transactions, e.g., some of the transactions are very important and have to be delivered (so having a high priority) while some other transactions may not that important and the Full BCN may cancel their delivery (so having the lowest priority) if the network resources are so limited. Alternatively, those transactions may have different delivery delay deadlines (e.g., some of the transactions need to be delivered as soon as possible while other transactions may be delivered at a later time because of a larger tolerable delay). Again, the Version 2 solution might not use CDIP and might not enable any helping among DCs.

### Representative Version 3 of ABOO

The ABOO only considers the “helping” aspect and the main task of the ABOO is to enable the helping among DCs.

Applicable Scenario: The DCs deploy their respective IBDIs in the blockchain network (CDIP is not used in Version 3). However, DCs may not have full-fledged capabilities/capacities for obtaining/processing the desired blockchain data. For example, at a certain time, a DC may have a very bad connectivity quality with a Full BCN and needs to rely on another DC as a helper to retrieve blockchain data from the blockchain network. Another example, a BCN may not have the required transaction processing capability/capacity and needs to borrow the desired capabilities or capacities of other DCs (as helpers). In Version 3, the DCBCs of DCs will register to ABOO. Each DC still uses its respective IBDI. For example, given a set of filtered transactions to be delivered to DC-1, the task of ABOO is to assign one or more helps to help the blockchain data delivery/processing for DC-1. No CDIP and no priority list may be involved in this version.

In addition, it is worth noting that other potential combinations are also possible. For example:

### Representative Version 4 of ABOO

In this version, the ABOO considers the “sharing +helping” aspects. In Version 4, CDIP and DCBCs will be included. But the ABOO will not address the “contention” among DCs. In this solution, once a set of transactions are filtered out using CDIP, they will be treated equally (i.e., having the same priority and no blockchain data delivery priority is involved). Then, the ABOO will assign helpers if needed for delivering those filtered transactions.

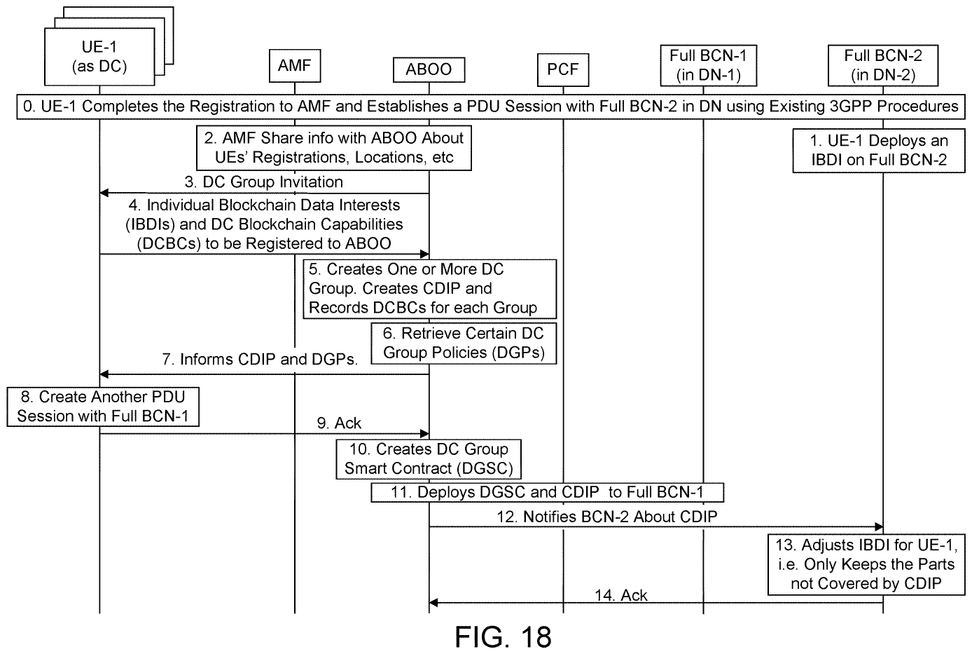

FIG. 17 shows a 3GPP SA2 embodiment. This embodiment may include one or more options, such as:
Option 1: In this basic scenario, UEs are the DCs. There are two ways for hosting the proposed ABOO. The first choice is that a UE, a terminal, a CPE or an eRG (acting as a Coordinator DC) may install an ABOO such that a DC group may be established, e.g., if multiple nearby DCs are residing in the same local area as the Coordinator DC. In this approach, different DCs may interact with each other e.g., through the Device-To-Device (D2D) communication. The second choice is that the ABOO may be deployed on a gNB base station or any other edge terminal, such as roadside unit, gateway, set top box. In this case, the UEs acting as DCs may interact with the ABOO via the wireless connection to the base station. In addition, in Option 1, the Full BCNs may be deployed in the Data Network (DN), e.g., in the cloud. Accordingly, UEs (acting as DCs) will interact with the Full BCNs via RAN and UPF.
Option 2: In this scenario, DCs may be various Network Functions (NFs) in the Core Network. The proposed ABOO may be a new NF in the Core Network or the ABOO could be edge application server deployed in an edge data network. In the meantime, the existing UDR and UDSF may be equipped with the blockchain capability, e.g., installing Full BCNs on those NFs. The Full BCNs may also be available in DNs. Accordingly, UEs (acting as DCs) will interact with the Full BCNs via RAN and UPF. Therefore, blockchain interactions mainly happen between UDR/UDSF and other NFs that need to access data from blockchain system, such as AMF, SMF, NWDAF, etc.

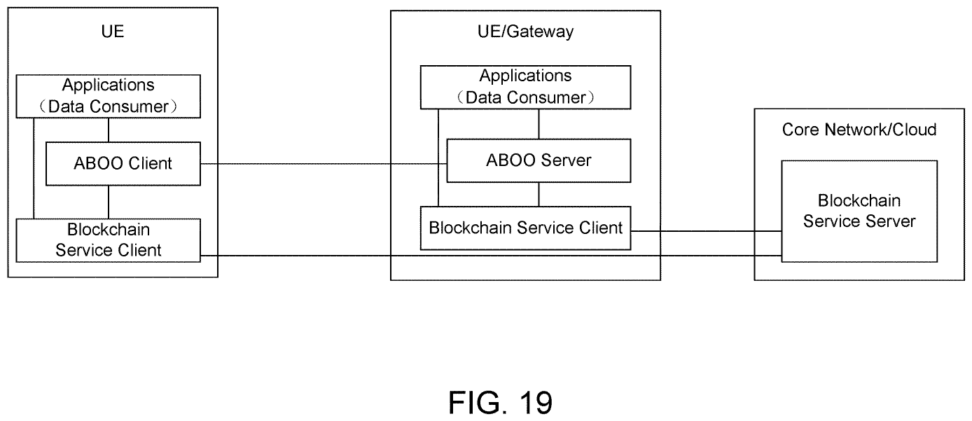

FIG. 18 illustrates an example procedure 1800 for enabling and/or carrying out CDIP creation and/or DCBC registration. The procedure 1800 is described with reference to the communications system 100 (FIG. 1) for convenience and simplicity of exposition. The procedure 1800 may be carried out using different architectures as well. The procedure 1800 may be suitable (used) for scenarios in which an ABOO may initiate CDIP creation and/or DCBC registration, e.g., where ABOO is a new core network function. The procedure 1800 is similar to the procedure 1000 of FIG. 10.

Step 0. UE-1 completes the registration to AMF. In the meantime, UE-1 (as a DC) has already established a PDU session (via SMF) with the Full BCN-2 in a DN so that UE-1 may interact with the blockchain system. All of those could be conducted using existing 3GPP procedures. However, during the registration procedure, new parameter(s) may be added so that the AMF may advertise the ABOO NFs to UEs, and in turn, UEs may indicate whether they want to use the service provided by ABOO. Alternatively, if AMF did not indicate ABOO service to UEs during the registration stage, it may also be done during the PDU session establishment stage. For example, when the UE requests the SMF to build a new PDU session connected to a Full BCN, the SMF may know that this UE needs to interact with the blockchain system. Accordingly, this UE may be a potential DC that may want to use the ABOO service. Therefore, during the PDU session establishment procedure, new parameter(s) may be added so that the UEs may indicate whether they want to use the ABOO service in order to optimize the blockchain-related traffic and processing.

Step 1. UE-1 deploys its IBDI on Full BCN-2. This step corresponds, and/or is akin, to the Step 1 in FIG. 10.

Step 2. For UEs, once they register with the 3GPP network, the AMF could share information with ABOO NF about UEs' registration information, current locations, etc.

Step 3. The ABOO intends to create a DC group in order to optimize the communication and computing overhead/cost for a given area. Accordingly, ABOO may send DC group invitations to the desired UEs. This step corresponds, and/or is akin, to Step 2 in FIG. 10.

Step 4. This step corresponds, and/or is akin, to Step 3 in FIG. 10.

Step 5. This step corresponds, and/or is akin, to Step 4 in FIG. 10. However, in this case, since ABOO is a 5G Core Network Function, it could be assumed that UEs may trust this ABOO. Therefore, no individual smart contract needs to be created between ABOO and each UE as shown in FIG. 10 (in which ABOO is deployed on an untrusted UE or an edge terminal).

Step 6. The ABOO may need to contact PCF in order to retrieve the related DC group policies.

Step 7. This step corresponds, and/or is akin, to Step 5 in FIG. 10.

Step 8. This step corresponds, and/or is akin, to Step 6 in FIG. 10.

Step 9. This step corresponds, and/or is akin, to This step corresponds, and/or is akin, to Step 7 in FIG. 10.

Step 10. This step corresponds, and/or is akin, to Step 8 in FIG. 10.

Step 11. This step corresponds, and/or is akin, to Steps 9 and 10 in FIG. 10.

Step 12. This step corresponds, and/or is akin, to Step 11 in FIG. 10.

Step 13. This step corresponds, and/or is akin, to Step 12 in FIG. 10.

Step 14. This step corresponds, and/or is akin, to Step 13 in FIG. 10.

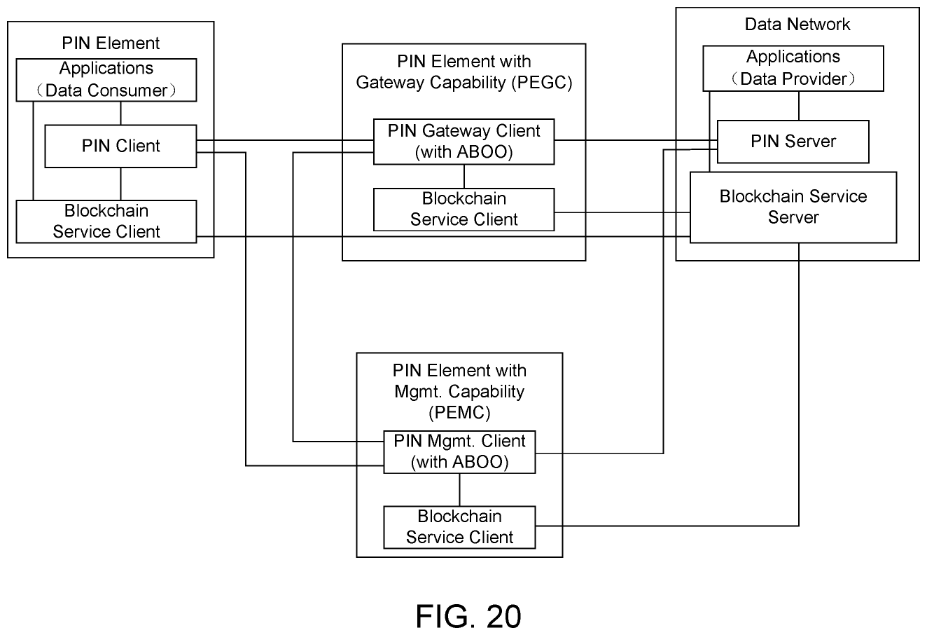

In addition, FIG. 19 shows a SA6 embodiment. This embodiment is aligned with an existing 3GPP SA6 architecture, which adopts a Client-Server model. For example, a blockchain service layer may contain the blockchain service client-side and the blockchain service server-side. The UEs or the gateway may install a blockchain service client. For example, the lightweight blockchain node installed on a UE may be regarded as the blockchain service client side. On the other hand, Full BCN may be regarded as the Blockchain service server side, so that the blockchain service client side may interact with the blockchain service server side. Accordingly, the blockchain service client side may deploy their IBDIs on the blockchain service server. The blockchain service server may apply the IBDIs and deliver the filtered blockchain transactions to the blockchain service client side. The proposed ABOO may also have two parts, the ABOO client and the ABOO server. The ABOO client may be installed on UEs (acting as DCs) while the ABOO server may be either installed on a UE (i.e., acting as a Coordinator DC) or on a local gateway. The applications installed on the UEs or gateway may be regarded as the final consumers (i.e., DCs) of the data obtained from the blockchain service server side. Accordingly, UEs installing the ABOO client may send their IBDIs to the ABOO server and also register their DCBCs to the ABOO server. Then, the ABOO Server may use this information for creating a CDIP and deploy the CDIP to the blockchain service server in the cloud.

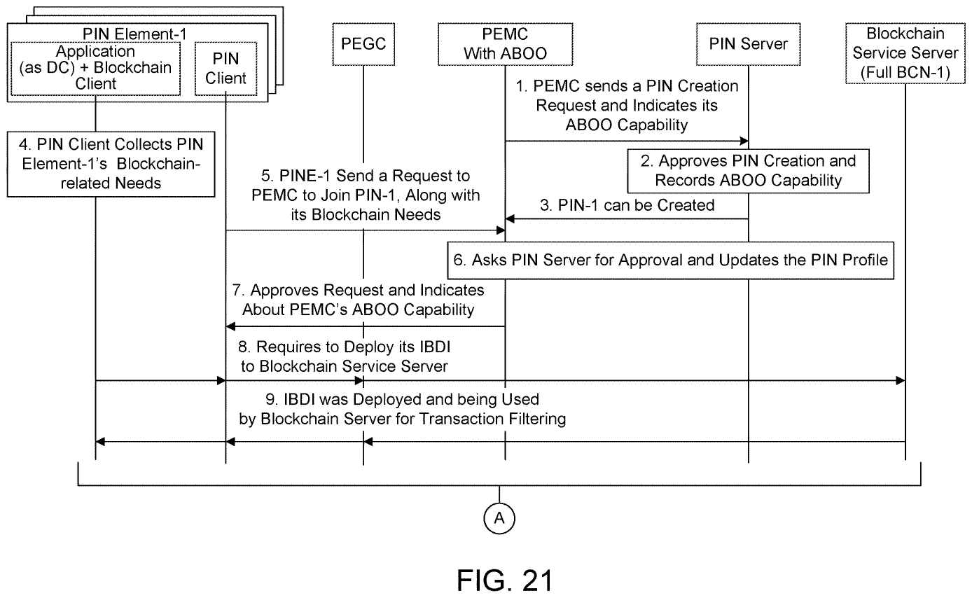

Another SA6 embodiment using PIN architecture is shown in FIG. 20. In this embodiment, various PIN elements may directly interact with each other via PIN client. In particular, the proposed ABOO may be implemented by the PIN Gateway Client, which is hosted by PEGC. Alternatively, the proposed ABOO may be implemented by the PEMC. In addition, the application server hosted in the data network may be regarded as the data providers.

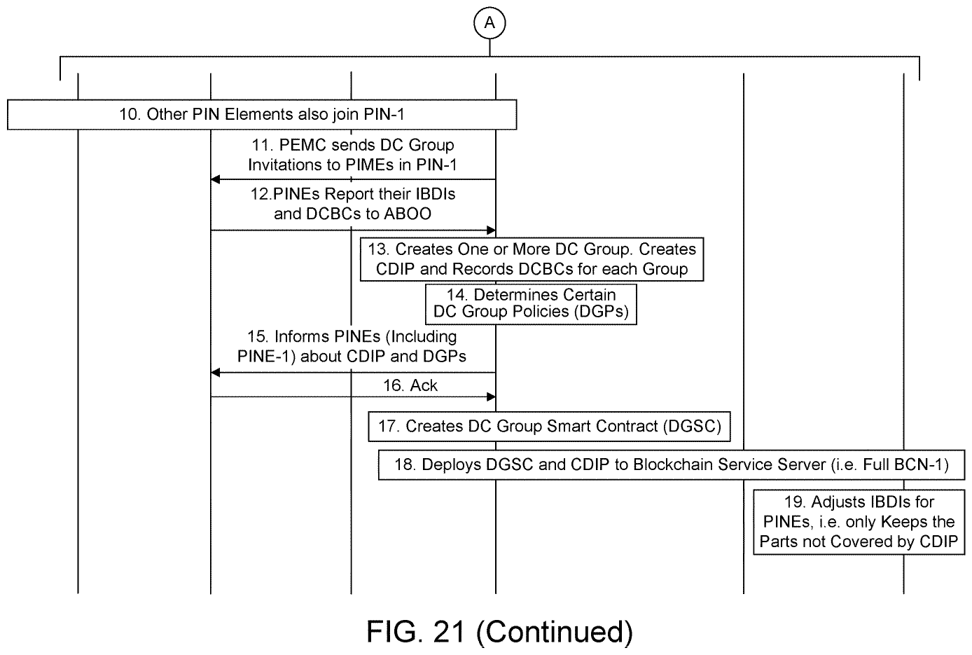

FIG. 21 illustrates an example procedure 2100 for enabling and/or carrying out CDIP creation and/or DCBC registration. The procedure 2100 is described with reference to the communications system 100 (FIG. 1) for convenience and simplicity of exposition. The procedure 2100 may be carried out using different architectures as well. The procedure 2100 may be suitable (used) for scenarios in which an ABOO may initiate CDIP creation and/or DCBC registration, e.g., where ABOO is realized by a PEMC. The procedure 2100 is similar to the procedure 1000 of FIG. 10 and the procedure 1800 of FIG. 18.

Step 1. PEMC sends a PIN creation request to PIN Server. In the meantime, the PEMC may indicate its ABOO capability (which also means that OEMC has a blockchain client and may interact with the Blockchain Service Server). In the meantime, the PEMG may also indicate blockchain-related capabilities for PEGC and/or PINEs that it intends to include in the PIN to be created (If PEMC already knows which PINEs shall be included).

Step 2. PIN Server approves the PIN creation request and also records ABOO capability. In the meantime, the PIN Server may decide on certain DC group-related policy suggestions to be used by PEMC.

Step 3. PIN Server sends back an acknowledgment to PEMC, along with useful information, such as DC group-related policy suggestions. Accordingly, the PEMC may create a new PIN network, such as PIN-1. In particular, the PIN response may also include the indication about which specific PIN elements shall be included in the PIN to be created.

Step 4. PIN Element (PINE)-1 hosts an application (acting as Data Consumer or DC). The PINE-1 also hosts a blockchain client. In this embodiment, the DC application plus the blockchain client may be treated as a whole, and they may be defined as a PIN application, which indicates their blockchain-related needs and the requirements to the PIN client installed on PINE-1. Assuming PINE-1 has discovered PIN-1 using the existing PIN discovery solution, PINE-1 now intends to join PIN-1. In another case, it is also possible that an application (as DC) is installed on PINE-1 but PINE-1 does not install a BC client. If that is the case, the PINE-1 may rely on the BC client installed on PEGC to interact with the blockchain system.

Step 5. The PIN client of PINE-1 sends a request to PEMC in order to join PIN-1. Also, it indicates that PINE-1 has the requirements or needs for interacting with a blockchain system (via a Blockchain Service Server, which hosts a Full BCN-1).

Step 6. PEMC contacts the PIN server to ask for approval for adding PINE-1 to the PIN-1, using the existing approach. The PIN Server may approve the request and then updates the PIN profile of PIN-1.

Step 7. PEMC sends back an acknowledgment to PINE-1 that PINE-1 has already been added to PIN-1. In the meantime, PEMC also indicates that it has the ABOO capability. Or if a particular PEGC has the ABOO or blockchain capability, the PEMC also indicates to PINE-1 about which specific PEGC has the ABOO capability and it should connect to (e.g., if PINE-1 itself does not install a Blockchain client).

Step 8. PINE-1 connects to the Blockchain Service Server via PEGC. Also, PINE-1 deploys its IBDI onto the Full BCN-1 hosted by the Blockchain Service Server. This step corresponds, and/or is akin, to Step 1 in FIG. 10. Alternatively, in case where PINE-1 needs to connect to the Blockchain Service Serer via a proxy, PINE-1 may send the IBDI to the proxy (e.g., PEGC) so that proxy may further deploy the IBDI to the blockchain server.

Step 10. Other PINEs will also join PIN-1. Those PINEs may also have blockchain clients and need to interact with the blockchain system.

Step 11. The PEMC (having ABOO capability) intends to create a DC group within PIN-1 in order to optimize the communication and computing overhead/cost for PIN-1. This may also be triggered by PIN Server or by the underlying 5GS. Accordingly, PEMC may send DC group invitations to the PINEs in the PIN-1. This step corresponds, and/or is akin, to Step 2 in FIG. 10.

Step 12. This step corresponds, and/or is akin, to Step 3 in FIG. 10.

Step 13. This step corresponds, and/or is akin, to Step 4 in FIG. 10. However, in this case, since ABOO is hosted by PEMC, it could be assumed that PINEs may trust this ABOO. Therefore, no individual smart contract needs to be created between PEMC and each PINE as shown in FIG. 10 (in which ABOO is deployed on an untrusted UE or an edge terminal).

Step 14. The PEMC selects and defines a set of appropriate GCPs based on the DC group policy suggestions sent from the PIN Server in Step 3.

Step 15. This step corresponds, and/or is akin, to Step 5 in FIG. 10.

Step 16. This step corresponds, and/or is akin, to Step 7 in FIG. 10.

Step 17. This step corresponds, and/or is akin, to Step 8 in FIG. 10.

Step 18. This step corresponds, and/or is akin, to Steps 9 and 10 in FIG. 10.

Step 19. This step corresponds, and/or is akin, to Step 12 in FIG. 10.

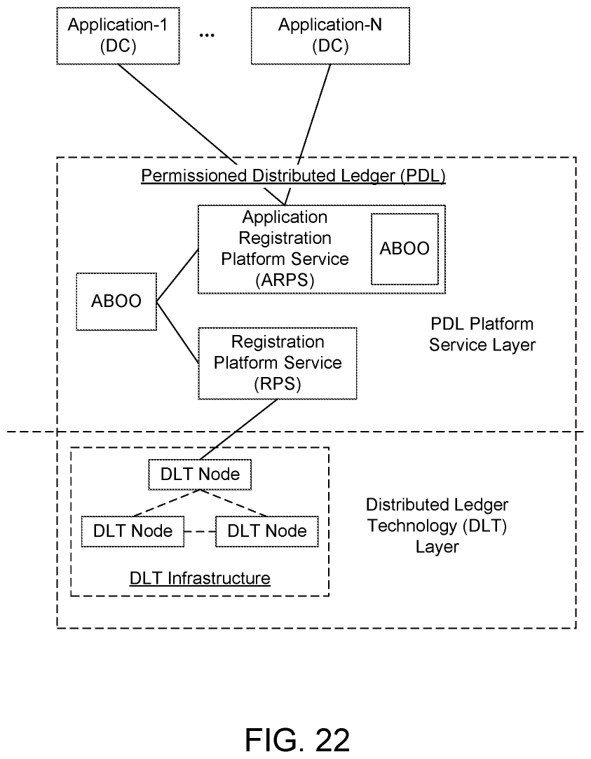

FIG. 22 shows an example of an ETSI PDL embodiment. In this embodiment, the applications are the users of PDL systems, which may be regarded as DCs. There are two options for implementing the proposed ABOO in the PDL architecture. The first option is that the proposed ABOO may be embodied as a new function of the existing Application Registration Platform Service (ARPS). Accordingly, when the applications register with the ARPS, they may also send their IBDIs and DCBCs to the ARPS. The ARPS may further interact with the Registration Platform Service (RPS), with which various DLT nodes are registered. The second option is that the proposed ABOO may also be implemented as a new platform service in the PDL architecture. Accordingly, the ABOO service may monitor the application registration requests sent from the applications to the ARPS and provide the corresponding optimization supports to those DCs.

### Conclusion

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.) and/or “permissive” terms (e.g., the term “is” and/or the term “are” may be interpreted as “may” and/or “might”, the terms “refer(s)” may be interpreted as “may refer” and/or “might refer”, the terms “receive(s)” may be interpreted as “may receive” and/or “might receive”, the terms “support(s)” may be interpreted as “may support” and/or “might support”, the terms “interface(s)” may be interpreted as “may interface” and/or “might interface”, the terms “transmit(s)” may be interpreted as “may interface” and/or “might interface”, “may transmit” and/or “might transmit”, the terms “send(s)” may be interpreted as “may send” and/or “might send”, the terms “does not refer” (and/or the like) may be interpreted as “may not refer” and/or “might not refer”, the terms “does not receive” (and/or the like) may be interpreted as “may not receive” and/or “might not receive”, the terms “does not support” (and/or the like) may be interpreted as “may not support” and/or “might not support”, the terms “does not interface” (and/or the like) may be interpreted as “may not interface” and/or “might not interface”, the terms “does not transmit” (and/or the like) may be interpreted as “may not transmit” and/or “might not transmit”, the terms “does not send” (and/or the like) may be interpreted as “may not send” and/or “might not send”, etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 25 U.S.C. § 112, ¶ 6 or means-plus-function claim format, and any claim without the terms “means for” is not so intended.

1. A first device comprising circuitry, including a transmitter, receiver, a processor and memory, configured to:
transmit a first transmission to a processing device of a distributed ledger via any of a wireless and wired medium, wherein the first transmission comprises information indicating collective data interest plan (CDIP) content, including filters for filtering transactions for the first device and a second device;
receive a second transmission from the processing device via any of the wireless and wired medium, wherein the second transmission comprises information indicating a summary digest for multiple filtered transactions;
generate first and second transaction set units (TSUs) based on the summary digest, wherein:
(i) the first TSU comprises a first one or more of the multiple filtered transactions of a first type, and
(ii) the second TSU comprises a second one or more of the multiple filtered transactions of a second type; and
transmit, to the processing device based on respective priorities of the first and second TSUs, information indicating to the processing device to transmit to the second device one of the first and second TSUs.

2. The first device of claim 1, configured to transmit, to the processing device, information indicating to the processing device to drop or discard at least one of the first TSU and the second TSU based on the respective priorities of the first and second TSUs.

3. The first device of claim 1, configured to select the second device based on, at least on part, processing power of the second device and a quality metric of a communication link between the second device and the first device.

4. The first device of claim 1, wherein each of the first one or more of the multiple filtered transactions of a first type comprise a first type of data, and wherein each of the second one or more of the multiple filtered transactions of a second type comprise a second type of data.

5-7. (canceled)

8. The first device of claim 1, wherein at least one of:
the first device operates as a data coordinator; and
the first device or the second device operates as a data consumer.

9. (canceled)

10. The first device of claims 1, wherein the second device is a blockchain node.

11. A method implemented in a first device, the method comprising:
transmitting a first transmission to a processing device of a distributed ledger via any of a wireless and wired medium, wherein the first transmission comprises information indicating collective data interest plan (CDIP) content, including filters for filtering transactions for the first device and a second device;
receiving a second transmission from the processing device via any of the wireless and wired medium, wherein the second transmission comprises information indicating a summary digest for multiple filtered transactions;
generating first and second transaction set units (TSUs) based on the summary digest, wherein:
(i) the first TSU comprises a first one or more of the multiple filtered transactions of a first type, and
(ii) the second TSU comprises a second one or more of the multiple filtered transactions of a second type; and
transmitting, to the processing device based on respective priorities of the first and second TSUs, information indicating to the processing device to transmit to the second device one of the first and second TSUs.

12. The method of claim 11, further comprising:
transmitting, to the processing device, information indicating to the processing device to drop or discard at least one of the first TSU and the second TSU based on the respective priorities of the first and second TSU.

13. The method of claim 11, comprising selecting the second device based on, at least in part, processing power of the second device and a quality metric of a communication link between the second device and the first device.

14. The method of claim 11, wherein each of the first one or more of the multiple filtered transactions of a first type comprise a first type of data, and wherein each of the second one or more of the multiple filtered transactions of a second type comprise a second type of data.

15-17. (canceled)

18. The method of claim 11, wherein at least one of:
the first device operates as a data coordinator; and
the first device or the second device operates as a data consumer.

19. (canceled)

20. The method of claim 11, wherein the second device is a blockchain node.

21. (canceled)

22. The method of claim 11, wherein the second device comprises at least one of (i) a group of devices and (ii) one or more wireless transmit/receive units (WTRUs).

23. The method of claim 11, further comprising:
determining one or more third devices; and
assigning one or more tasks to the one or more third devices for transmitting the one of the first and second TSUs.

24. A wireless transmit/receive unit (WTRU) comprising circuitry, including a transmitter, receiver, a processor and memory, configured to perform a method as in claim 11.

25. An wireless transmit/receive unit (WTRU) comprising circuitry, including a transmitter, receiver, a processor and memory, configured to perform a method as in claim 12.

26. The first device of claim 1, wherein the second device comprises at least one of (i) a group of devices and (ii) one or more wireless transmit/receive units (WTRUs).

27. The first device of claim 1, configured to:
determine one or more third devices; and
assign one or more tasks to the one or more third devices for transmitting the one of the first and second TSUs.

28. The first device of claim 1, configured to:
determine the respective priorities of the first and second TSUs based on, at least in part, any of (i) available communication resources, and (ii) the first and second types.

29. The method of claim 11, comprising:
determining the respective priorities of the first and second TSUs based on, at least in part, any of (i) available communication resources, and (ii) the first and second types.
